(19) United States
(12) Patent Application Publication
(10) Pub. No.: US 2008/0228599 A1
(43) Pub. Date: Sep. 18, 2008

(54) Color Selection, Coordination, Purchase and Delivery System

(75) Inventors: Marc Webb, Orange, CA (US); Damien Reynolds, Huntington Beach, CA (US); Mary Rose Rice, Laguna Niguel, CA (US)

Correspondence Address: GREENBERG TRAURIG LLP (LA), 2450 COLORADO AVENUE, SUITE 400E, INTELLECTUAL PROPERTY DEPARTMENT, SANTA MONICA, CA, 90404, US

(73) Assignee: Behr Process Corporation

(21) Appl. No.: 12/128,582

(22) Filed: May 28, 2008

Related U.S. Application Data
(63) Continuation of application No. 11/068,616, filed on Feb. 28, 2005.

(51) Int. Cl. G06Q 40/00

(52) U.S. Cl. 705/27

(57) ABSTRACT

A system embodied as a website including a first, second and third pluralities of display screens, the first enabling an at-home user to select a first color which coordinates with a second selected color, the second enabling the user to select for purchase one or more of a plurality of interior decorating-related items, and the third enabling the user to order and pay for one or more of (a) a paint sample of each of said first and second colors and (b) at least one of the interior decorating-related items. The order may be automatically transmitted to a fulfillment center for fulfillment and then delivered to the user.

### CROSS REFERENCE TO RELATED APPLICATIONS

This application is a continuation of U.S. patent application Ser. No. 11/068,616, entitled “Color Selection, Coordination, Purchase And Delivery System,” filed on Feb. 28, 2005, which application is related to U.S. patent application Ser. No. 10/703,361, filed on Nov. 6, 2003 entitled “Distributed Color Coordination System”, now U.S. Pat. No. 7,193,632; to U.S. patent application Ser. No. 10/703,351, filed on Nov. 6, 2003 entitled “Data-Driven Color Coordinator”, now U.S. Pat. No. 7,230,629; to U.S. patent application Ser. No. 10/704,109, filed on Nov. 6, 2003 entitled “Color Selection and Coordination Kiosk and System”, now U.S. Pat. No. 7,330,585. The contents of the aforesaid patent application Ser. No. 11/068,616 and the other aforesaid patent applications are incorporated expressly by reference herein, as if fully set forth herein and full Paris Convention Priority is hereby expressly claimed. U.S. Pat. No. 6,563,510 entitled “Paint Color Matching and Coordination System” is further incorporated by reference herein.

### FIELD OF THE INVENTION

At least one embodiment of the invention relates to a system and method for aiding consumers in the selection of complementary colors of paint and other interior decorating items and which provides the consumer the ability to select and purchase samples of selected paint colors and other decorative materials from home.

### DESCRIPTION OF RELATED ART

Consumers typically begin a new painting or decorating project because of a desire for change. This desire typically stems from wanting a new look, being tired of the old look, boredom, seeing an interior to replicate elsewhere (e.g., model home tour, friend's house, magazine photo, etc.) and/or wanting to match a new piece of furniture, fabric, window treatment, etc. In other instances, a new event or occurrence (e.g., new baby, children growing up or moving out, relatives visiting, water damage from roof leak/flooding, etc.) may motivate a consumer to paint a room or rooms.

A paint project involves the selection of one or more colors, which a consumer typically wishes to have complement one another, the floor coverings, and/or furniture pieces. A consumer may start a paint project with a color in mind, or try to match furniture or other decorative items, or simply be looking for a new color. Regardless of how they start, most consumers wish to achieve a decorated look when finished, and typically look to brands, retailers, printed material and even computer programs to help them.

The related patent applications noted above pertain to various systems and methods for aiding a consumer in color selection and co-ordination, e.g., for interior or exterior decorating projects. Particular features provide decorating tools and information which can assist the consumer to conceive and visualize what the resulting decor may look like. One feature of such systems is the employment of a computer monitor or other electronic display device as a base for interactive consumer color selection. One aspect of such displays is that color reproduction on the display device may not be 100% accurate and thus the appearance of the color on the display screen may differ from the actual color of a selected paint once the paint has been applied to a surface such as an interior wall.

### SUMMARY

Accordingly, one embodiment of the subject invention provides a paint color selection and coordination system which enables “at-home” color validation through on-line ordering of samples of selected paint colors and related items and, optionally, the ultimate purchase of items for completion of a paint project. In this manner, a color coordination tool may be provided which can establish a common link for multiple decorating decisions. The tool may thus provide color coordinating advice and validation with respect to numerous decorating decisions, such as, for example, selection of kitchen and bath items and/or fixtures, carpet/tile, wall coverings, window treatments and paint.

### BRIEF DESCRIPTION OF DRAWINGS

FIGS. 1A-3 comprise sections of a flow chart illustrative of the structure and operation of an illustrative embodiment;

FIG. 4 is an illustration of a home page screen display;

FIG. 5 illustrates a browse color loading page screen display;

FIG. 6 illustrates an inspiration loading page;

FIG. 7 illustrates an explore color landing page;

FIG. 8 illustrates a color shop landing page;

FIG. 9 illustrates an at home designer selection page;

FIG. 10 illustrates a product detail web page;

FIG. 11 depicts an inspiration article web page;

FIG. 12 illustrates a web page including a pop-up inspirational scene;

FIG. 13 illustrates an add to cart page;

FIG. 14 illustrates a shopping cart web page;

FIG. 15 illustrates a user workbook web page;

FIG. 16 illustrates apparatus useful in implementing the web page functionality illustrated in FIGS. 1-3;

FIG. 17 is a flow chart of a process implementable in the environment of the system of FIGS. 1A-3;

FIG. 18 is a flow chart of a second process implementable in the environment illustrated in FIGS. 1A-3;

FIG. 19 is a flow chart illustrating a project fulfillment process according to an illustrative embodiment;

FIG. 20 is a perspective view of a fan deck color selector;

FIGS. 21-22 illustrate first and second initial color selection screens;

FIGS. 23-24 illustrate respective first and second screens presented after a user has scanned a paint sample to detect its color;

FIG. 25 illustrates an initial screen of a browse paint color selection feature according to an illustrative embodiment;

FIG. 26 illustrates a second screen of the browse feature enterable from the screen of FIG. 26;

FIG. 27 illustrates a screen display for activating a “change color family” feature;

FIG. 28 illustrates a screen display when associated whites are selected on either the screen of FIG. 26 or FIG. 27;

FIG. 29 illustrates a fourth screen of the browse selection feature which appears when the user clicks on one of the associated white icons illustrated in FIG. 28;

FIG. 30 illustrates a screen designed as part of the browse feature, for example when “neutrals/blacks” is selected on the screen of FIG. 25;

FIGS. 31, 37 and 32 illustrate additional screens related to browsing neutral colors;

FIG. 33 illustrates a screen enterable when a “whites” link is selected on the screen of FIG. 25;

FIG. 34 illustrates a screen providing a fine tune feature of a color selected, for example, via screens 26-28;

FIG. 35 illustrates the appearance of the screen of FIG. 34 when a user has selected the brightest color available;

FIG. 36 illustrates a screen which facilitates the fine tuning of neutral colors;

FIG. 38 illustrates a display screen facilitating the fine tuning of white colors selected, for example via the screen of FIG. 38;

FIGS. 39-44 illustrate screens for implementing a preferred functionality whereby a user may select a color and then build his/her own color palette;

FIGS. 45-50 depict screens of an illustrative embodiment providing an inspirational idea sequence to a user;

FIG. 51 illustrates a color selection table employable for example in a browse color selection method;

FIG. 52 is a schematic depiction of a four color paint selection palette;

FIGS. 53-58 are respective arc cross sections of 3-D color space useful in illustrating a method for determining first and second colors which match third and fourth colors already pre-selected by a user.

### DETAILED DESCRIPTION OF PREFERRED EMBODIMENTS

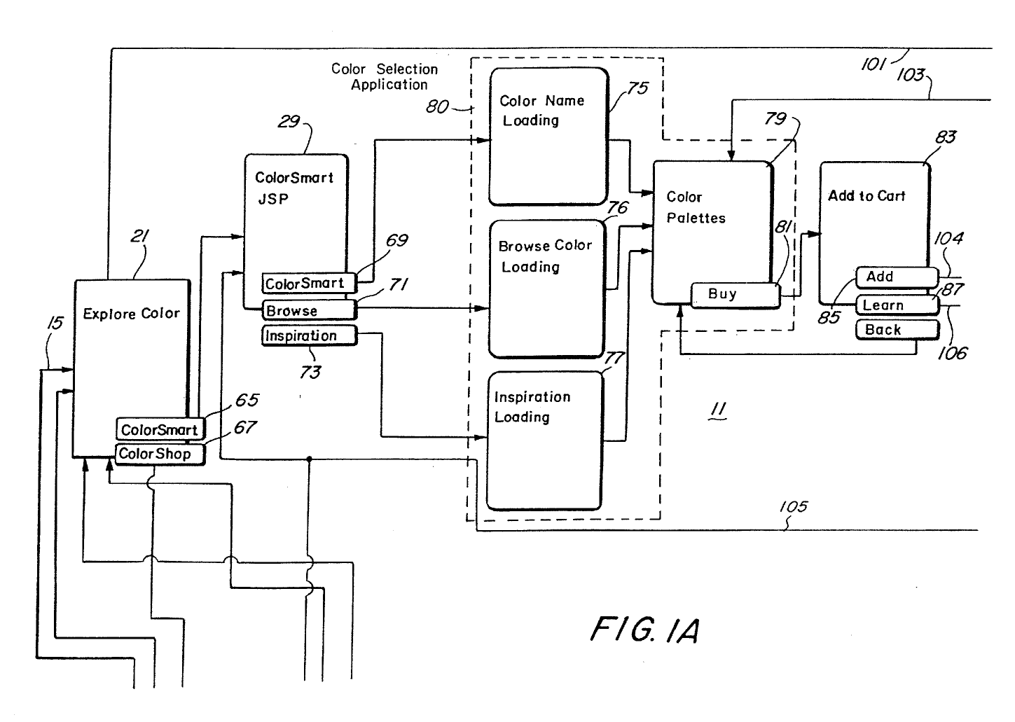

FIGS. 1A-3 comprise a flow chart illustrative of the structure and operation of an illustrative embodiment implementing features according to the invention. The embodiment of FIGS. 1A-3 is preferably implemented as a website having a home page 13. In general, each rectangular block depicted in FIGS. 1A-3 may represent an individual web page, typically providing a number of user selectable options. As will be apparent from the ensuing description, the functionality of various web pages may be combined into a single page or distributed among two or more alternate pages. The structure and functionality illustrated may be resident in other than a website. For example, the web pages may comprise screen displays of a discrete software program stored at a local site.

### Home Page Functionality

With respect to FIGS. 1A-1B, after executing conventional log-on operations, a user is provided with a home page 13. The home page 13 provides links 15, 17, 19 respectively, to a color exploration landing page 21, a color shop landing page 23 and an inspiration article page 25.

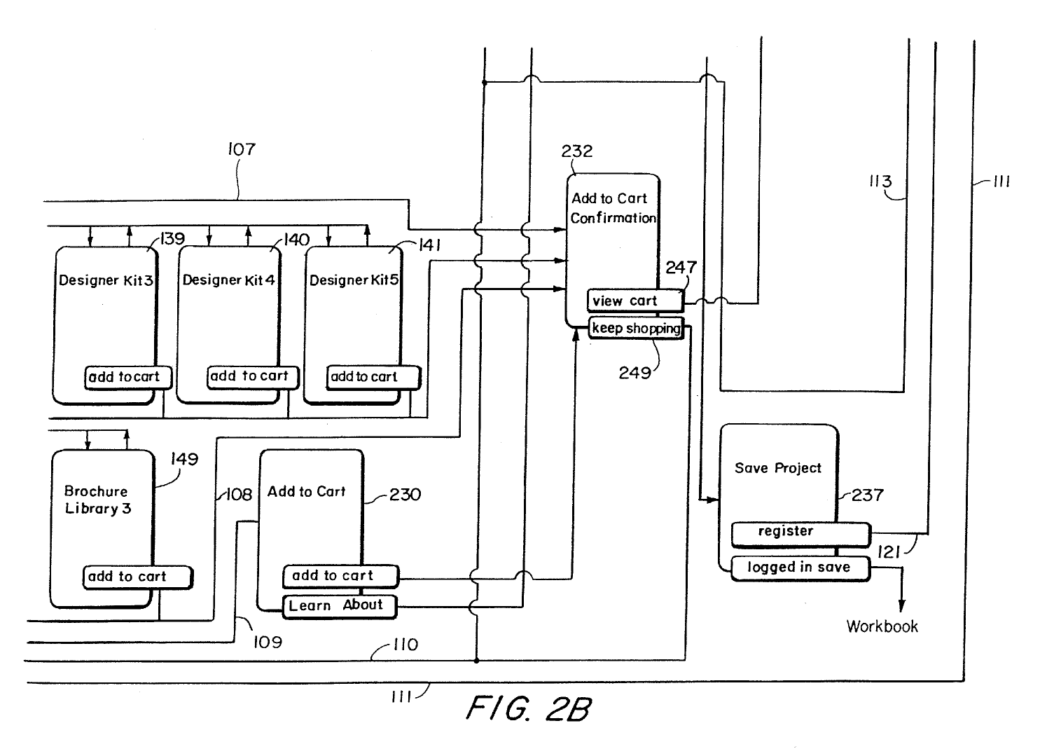

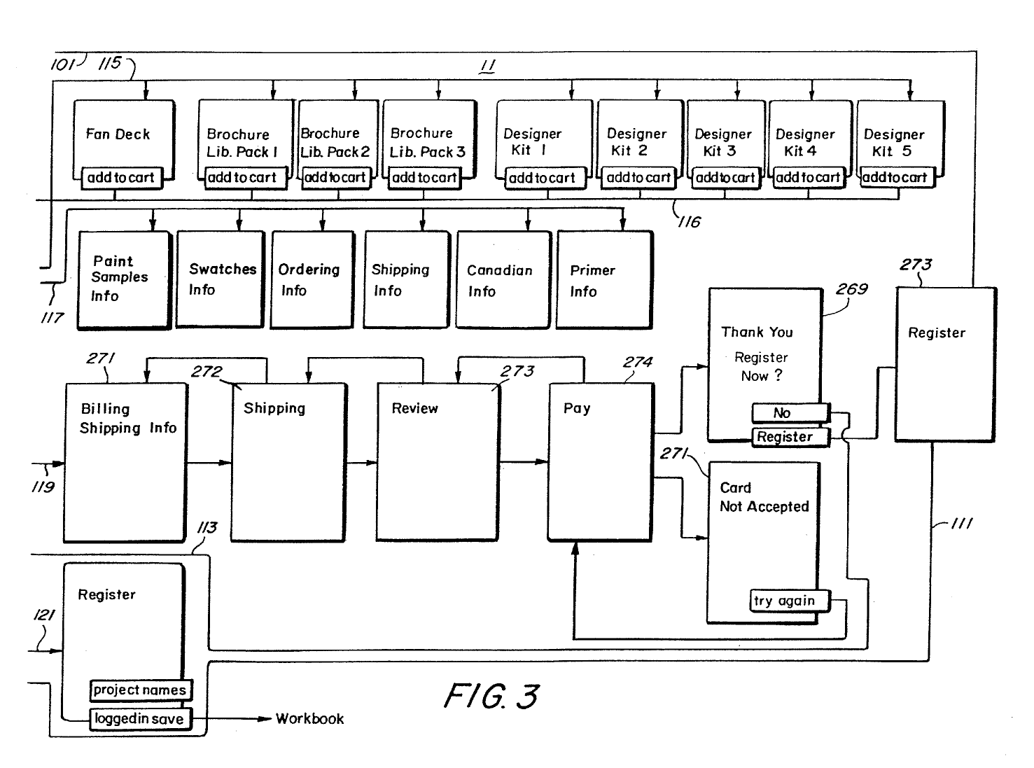

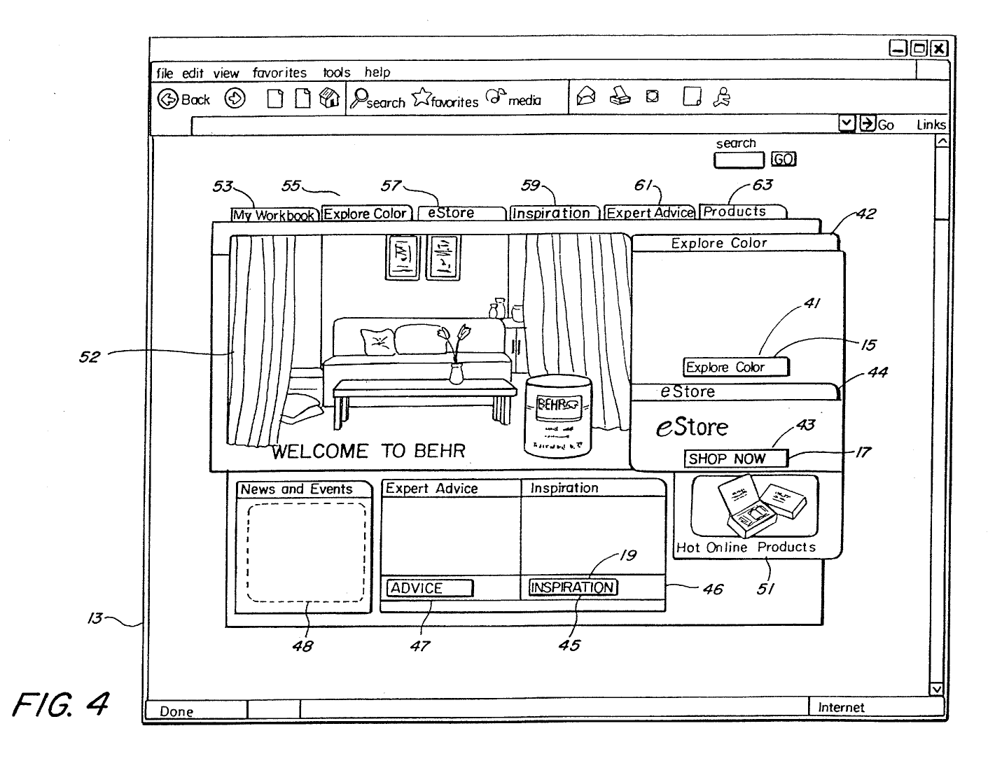

An illustrative home page 13 is shown on FIG. 4. The home page 13 of FIG. 4 includes a central rectangular room scene display 52 surrounded by, proceeding clockwise, an “explore color” informational block 42, an “e store” informational block 44, an inspiration informational block 46, an expert advice informational block 47, and a news and events informational block 48. In the illustrative embodiment, each of the informational blocks 42, 44, 46, 47, and 48 are generally rectangular in shape.

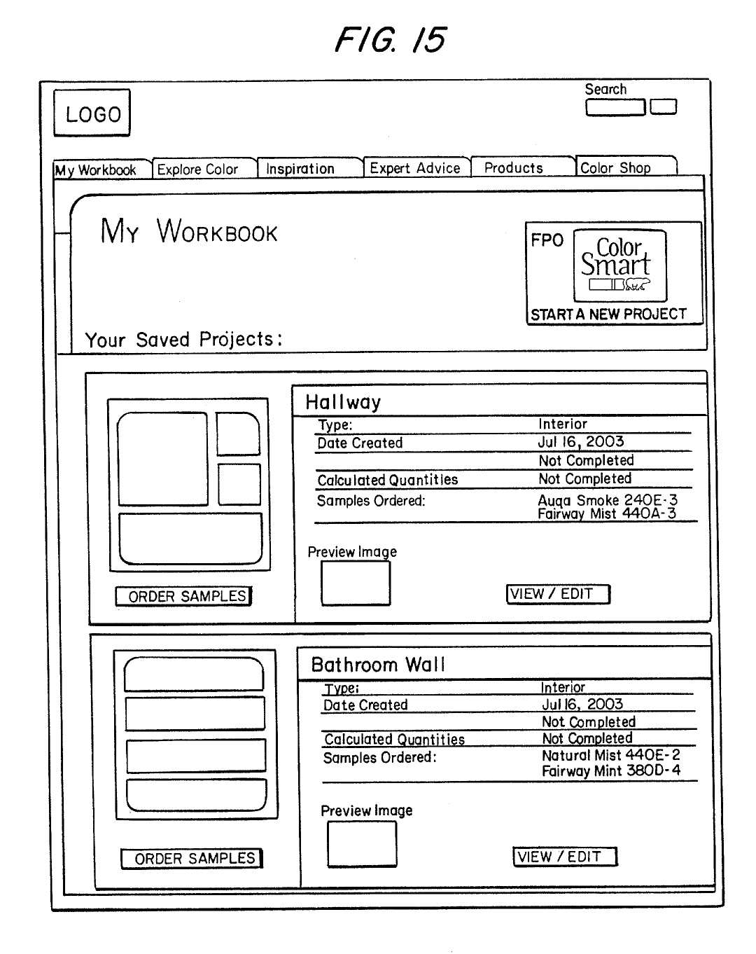

The home page 13 further includes top marginal tabs 53, 55, 57, 59, 61, 63, labeled respectively, “My Workbook”, “Explore Color”, “eStore”, “Inspiration”, “Expert Advice”, and “Products”. The tabs 55, 57, 59 again comprise links 15, 17, 19 of FIGS. 1A-1B, respectively. The “My Workbook” tab 53 may lead to a user maintained work book page such as illustrated in FIG. 15, which may store records of color palette selections and various other activities of the user. Expert Advice tabs 61 and Products tabs 63 may be provided to lead to an expert advice landing page and a product landing page, respectively.

The explore color informational block 42 of the home page of FIG. 4 includes an “explore color” button 41 whose selection comprises the selection of link 15 of FIG. 1A, resulting in display of the explore color landing page 21. The eStore block 44 includes a “shop now” button 43 whose selection comprises a selection of link 17, resulting in the display of the color shop landing page 23. The informational block 46 includes an inspiration button 45 whose selection comprises selection of a link 19 to the inspiration article landing page 25.

### Explore Color Functionality

### Color Selection, Coordination and Purchase

Returning to FIG. 1A-1B, the Explore Color landing page 21 includes first and second selection buttons 65, 67, which links to the color shop page 23 and a color selection software application start page 29. The color selection software application aids a user in selection of various colors of paint and then facilitates purchase of samples of the selected color(s) of paint online. The color selection application may be constructed according to the teachings of applicants' pending U.S. patent applications noted above and incorporated by reference herein.

As disclosed in the aforementioned Pending patent applications, a color selection software application 80 may provide a user with the capability to select a specific known color by name, or to browse through a selection of colors and choose matching (coordinated) colors, or to access an inspiration library designed to inspire color selection choices by the user. The color selection start page 29 facilitates user choice from among these three separate paths via three selection buttons 69, 71, 73.

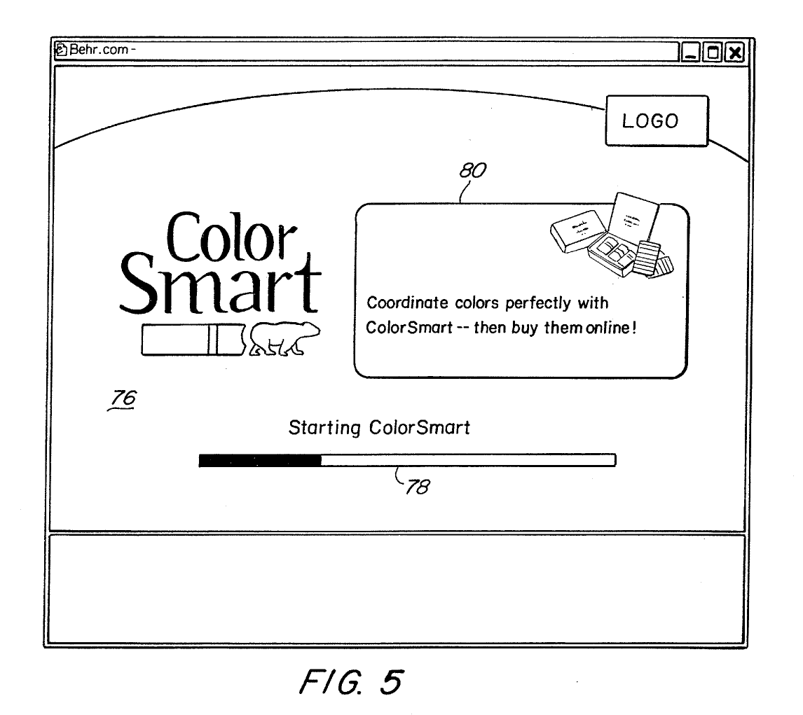

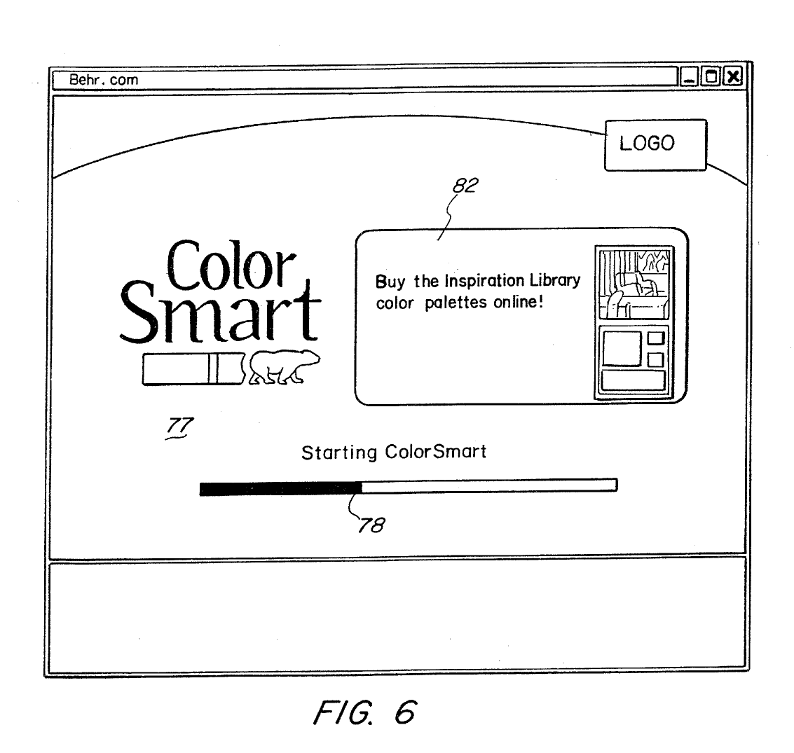

An example of a Browse Color loading page 76 is shown in FIG. 5. This page 76 transitions to the browse color selection portion of the color selection application. The user is informed of the progress of the system by a loading progress bar 78 as the color selection application is loading. The page 76 of FIG. 5 further includes a central, generally rectangular advisory block 80, which advises the user of the upcoming functionality, i.e. that the system will permit the user to select a palette of coordinated colors and then purchase paint samples of the selected colors on-line to be delivered directly to the user. An example of an inspiration loading page 77 is shown in FIG. 6. Again, this page 77 includes a central, generally rectangular advisory block advising the user that the upcoming functionality will permit the user to select an inspirational palette from a palette library and then have designer paint samples delivered direct to the user. If desired, the three respective loading pages 75, 76, 77 can be replaced by a single loading page which prefaces the selected functionality.

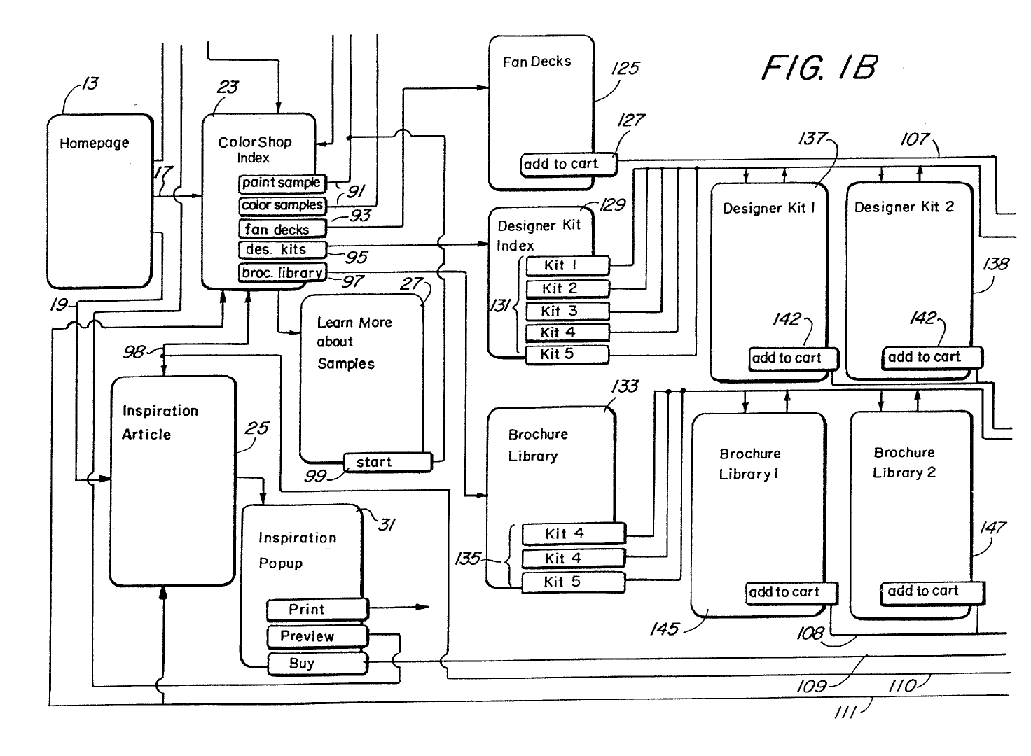

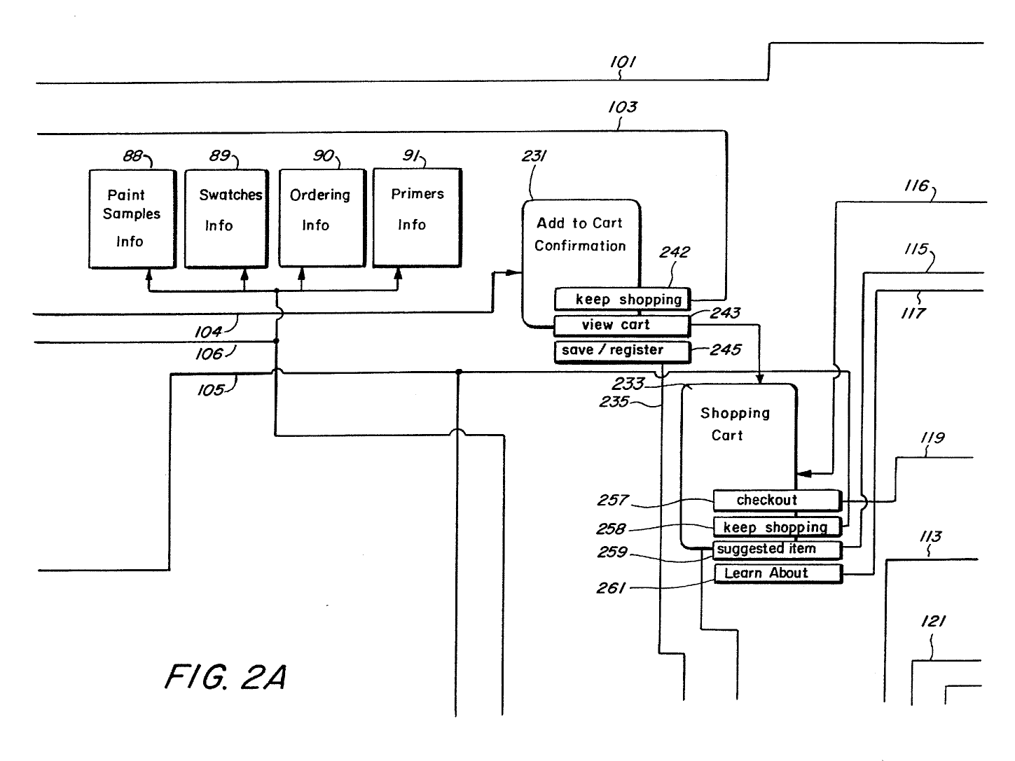

User interaction with the color selection application 80 may result in user selection of paint colors, for example, in the form of a color palette. Block 79 of FIG. 1A represents an order feature incorporated into various web pages of the color selection application 80 such that when a user has arrived at a desirable color palette or other color selection he or she may then select to purchase samples of paint corresponding to that color palette or color sample by activation of a “buy” button 81, which then actuates a link to the first of a number of shopping cart related pages such as an “add to cart” page 83. The add to cart page 83 includes a button 85, which activates a link 104 and permits paint samples and/or color samples to be added to the user's shopping cart. A second button 87 activates a link 106 to informational pages, e.g. 88, 89, 90, 91 of FIG. 2A, which provide information, for example, about paint samples, swatches, ordering information, and information about primers.

It will be appreciated that the color selection 80 application may include a tool by which to calculate the amount of paint that may be necessary for a room or exterior paint project. If the user is painting an exterior, then the system may request the size of the home, calculate the exterior values, and provides the amount of paint that should be necessary. Where the selected color scheme includes multiple colors, the system may determine the quantities of each paint color that are necessary to perform the particular project. Similarly, if the entire room is being painted, the system may request the user to select the size of the room and provide other information from which to calculate the amount of paint that is necessary to perform that project. A user may save this information, use it to order paint via the shopping cart functionality or print it as desired.

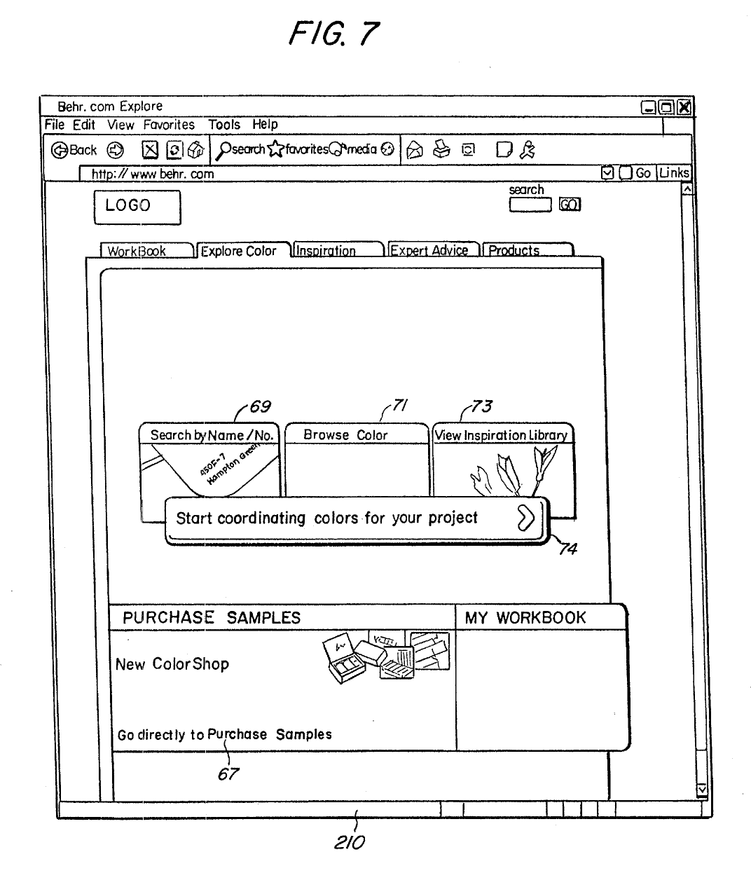

FIG. 7 illustrates an alternative and presently preferred embodiment 210 of an Explore Color landing page, which may serve as a substitute for both pages 21 and 29 of the embodiment of FIG. 1A. Accordingly, the page 210 incorporates the button 67 linking to the color shop landing page 23, as well as the three buttons 69, 71, 73 linking to the color loading pages 75, 76, 77 of FIG. 1A. The page 210 further includes marginal tabs linking to the user's workbook (FIG. 15), the inspiration article page 25, an expert advice page, and the products page.

### Color Shop Functionality

### On-Line Purchase of Selected Items

Returning to FIG. 1B, the Color Shop landing page 23 provides links which permit the selection and purchasing of fan decks, designer sample kits, and brochures. The Color Shop landing page 23 further provides a link to the Explore Color landing page 21 and may provide a link to a “Learn More” page 27, which provides information to the user regarding the functionality of the website and which may include a button linking 91 to the Color Selection landing page 21. The Color shop landing page 23 may further provide a link 98 to the inspiration article page 25.

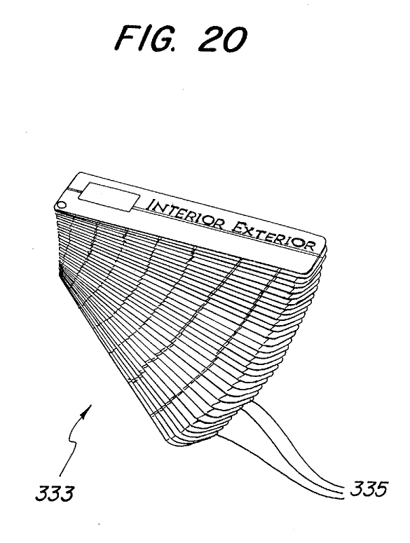

Further considering the links provided by the Color Shop landing page 23 of FIG. 1B, a button 95 provides a link to a designer kit index page 129, which includes selection buttons 131 permitting selection of one of a plurality of designer kits 137, 138, 139, 140, 141. A fan deck selection button 93 links to a fan deck selection page 125, including an add to cart selection button 127. A preferred fan deck 333 is illustrated in FIG. 20 and includes a plurality of pivotal blades 335, each of which may have seven different colors thereon and which may, for example, be sufficient in number to depict over 1600 available colors of a paint collection. Finally, a brochure library selection button 97 is provided linking to a brochure library selection page, which includes buttons 135 enabling selection of one of a plurality of brochure libraries 145, 147, 149. Each of the designer kit and brochure library pages includes an add to cart button 142 permitting selection of that particular item for addition to the user's shopping cart.

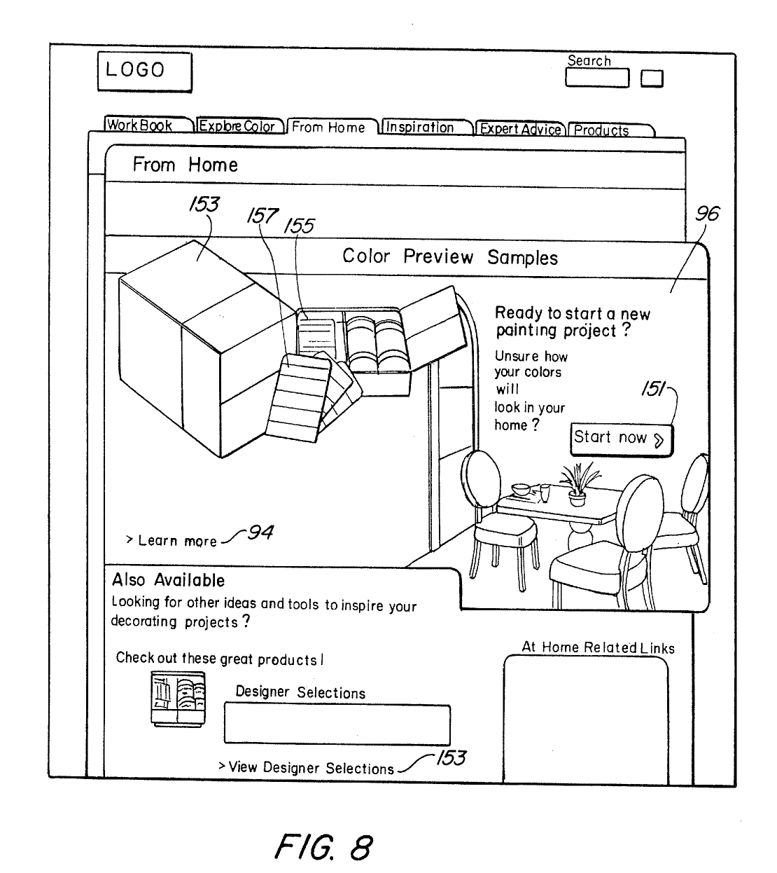

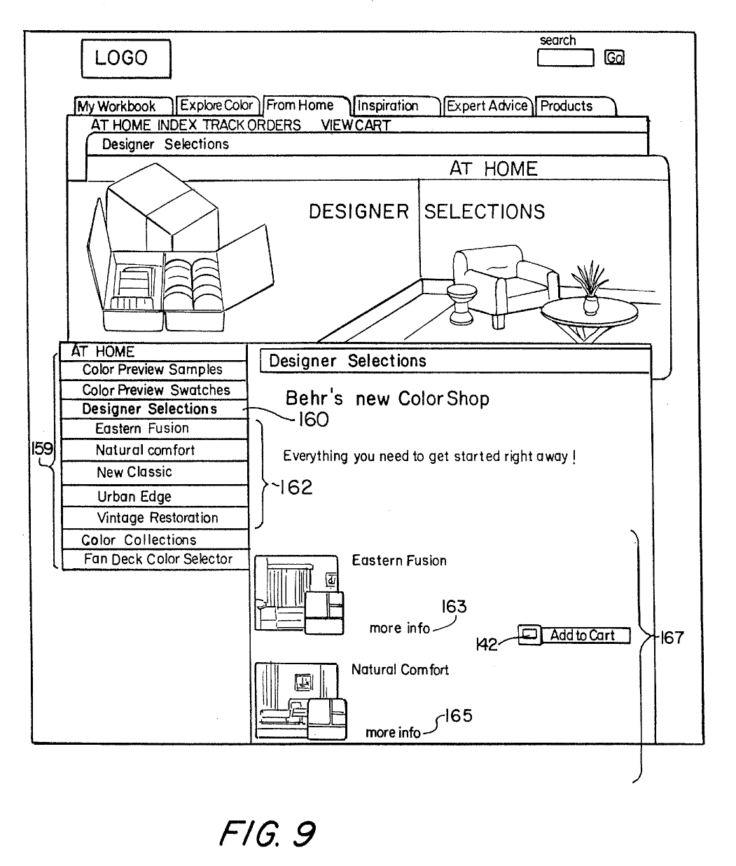

FIGS. 8 and 9 illustrate an alternative implementation of a color shop landing functionality similar to that provided by the landing page 23. FIG. 8 particularly illustrates a “From Home” screen display which includes a Start Now button 151, a Learn More link 94 and a “view designer selection” link 153. The Start Now button 151 is embedded in a room display with text inquiring as to whether the user is ready to start a new painting project but is unsure of how the colors the user has selected would look in the home. The Start Now button 151 provides a link to the Explore Color Landing page 21 from which the user may select colors, browse colors, or seek inspiration as discussed above.

The Learn More link of FIG. 8 lies within or adjacent to a generally rectangular area of the display which depicts a closed color sample pack 153, as well as a view of that same pack 155 opened up to display its contents. Those contents may include, for example, four 8 oz. paint samples, which have been custom made to conform to the user's selection from over 1600 colors or may comprise designer kits of four pre-selected colors, as described further below. The sample pack 155 may further include a plurality of rollers, roller trays, a roller handle and a matching preview swatch featuring stripes of the same colors as the samples, e.g., 157. Thus the kit 155 provides the user with everything needed to test the selected color sample set at home.

The designer selection link 153 of FIG. 8 links the user to the screen display of FIG. 9, an “At Home” designer selection page, which includes an index 162 of designer kits similar to that of the designer kit index page 129 of FIG. 1B. Such designer kits may be assembled to reflect the latest styles and trends such as, for example, Eastern Fusion, Natural Comfort, New Classic, Urban Edge, and Vintage Restoration styles. Each kit may contain 4 preview samples which have been previously coordinated by color experts.

The designer selection page of FIG. 9 particularly includes a list 159 providing links to pages featuring preview samples, preview swatches (color stripe cards), the fan deck color selector, e.g. 125, designer selection (designer kits), and color collection (brochures). Additional products may be added to the link list 159 such as carpet, flooring, fixtures, etc. In FIG. 9, the designer selection button 160 has been selected, causing a drop down display of the index 162 of a plurality of different designer styles. An “add to cart” link 142 is provided for each respective style, e.g. “Eastern Fusion”, to permit the customer to add the designer kit related to that style to the shopping cart.

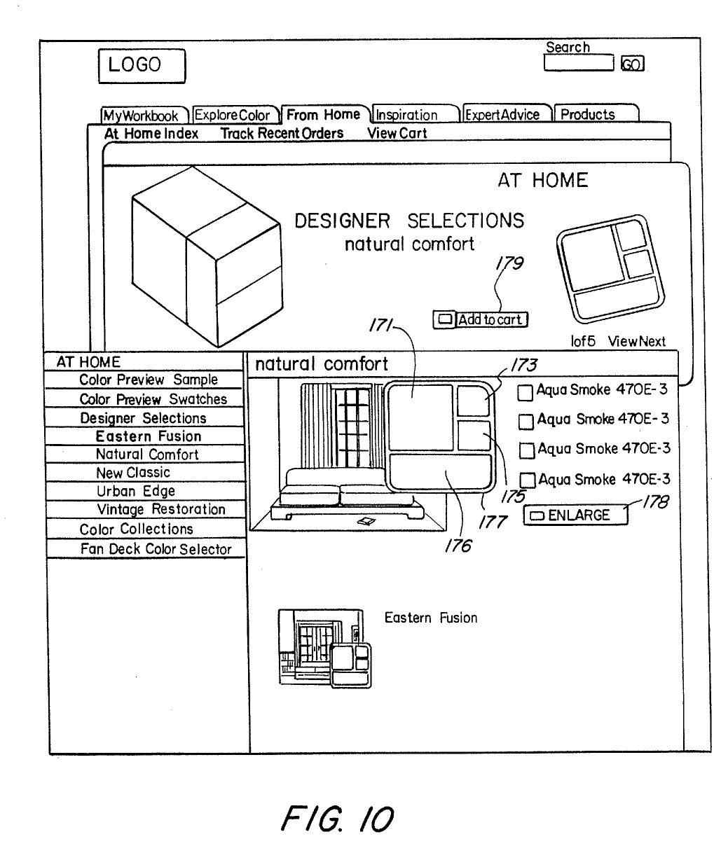

The display of FIG. 9 further provides a “More Info” link, e.g. 163, 165, for each style, which links to a screen display or web page such as illustrated in FIG. 10. FIG. 10 particularly illustrates to the user four coordinated colors 171, 173, 175, 176, arrayed in a centrally disposed color selection palette 177 associated with one particular style, in this case, “Natural Comfort”. An “Add to Cart” button is again provided in the event that the user wishes to purchase samples of the colors presented on the palette 177.

### Inspiration Article Page

FIG. 11 depicts an illustrative embodiment of an Inspiration Article page 25. The Inspiration Article page 25 features articles covering a variety of subjects, which are meant to inspire and motivate the reader to decorate and paint his or her home. An illustrative title of such an article is “Making so-so rooms look great.” An array of coordinated palettes is provided, and the reader is able to purchase the selected palette.

As illustrated in FIG. 11, five article links are provided across the top edge of the display: practical 181, artistic 183, emotional 185, fashionable 187 and historical 189. FIG. 11 particularly illustrates a case where the “artistic” link 183 has been selected. As a result, a number of links to artistic inspirational articles 193, 195 are provided. The user may select one of these links in order to read the related article.

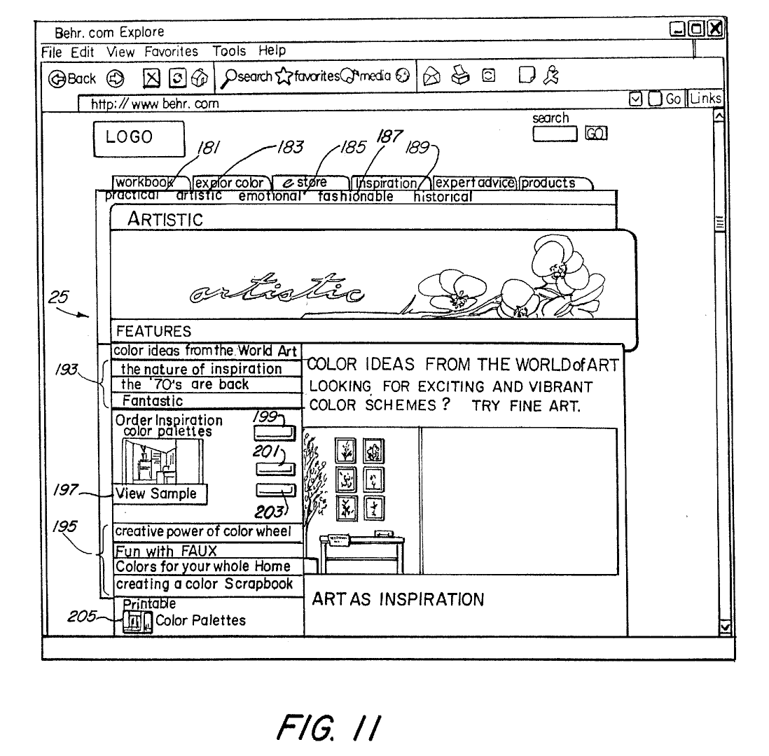

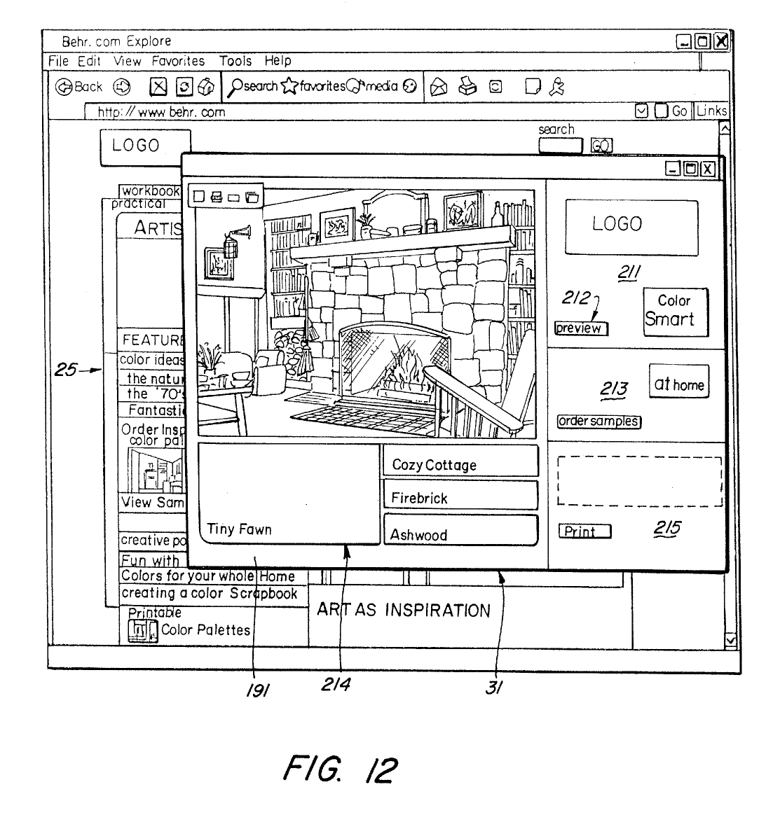

Upon clicking a small image of one of a series of inspirational scenes presented on FIG. 11, a pop-up 31 of an enlarged view of that scene together with a pre-selected color palette, for example, as illustrated in FIG. 12, is provided to the user. The inspiration pop-up 31 provides preview and buy options. The preview button 212 links back to the color selection application at a point where the user can choose one or more different rooms and view the colors of the palette 214 in each of those different rooms. Thus, the user could see the colors applied in a bedroom, or an entryway, for example.

Further with respect to FIG. 11, upon clicking a “view sample” button 197, the user is provided with a flash video (movie) instructing the user how to click on an image, view a palette and order. Upon clicking on a button 205, the user may view a flash video instructing the user how to print out a selected color palette.

### Purchase and Delivery

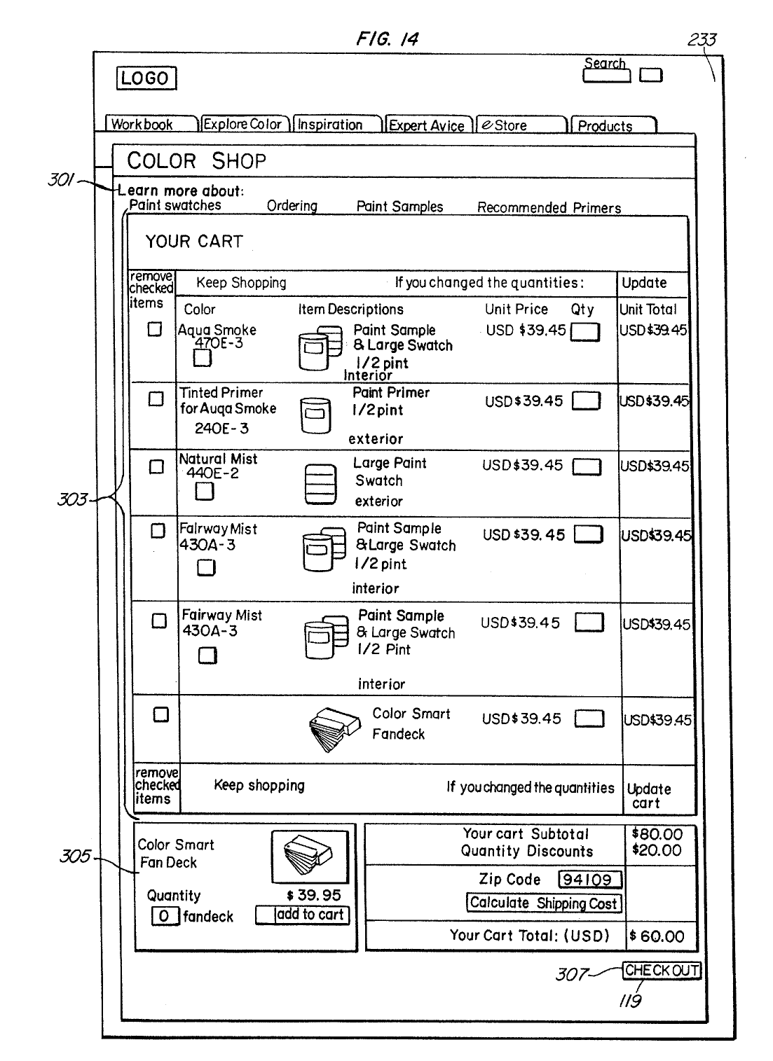

With respect to user purchases, a purchase selection initiated via an “add to cart” link 104 results in display of an add to cart confirmation page 231 (FIG. 2A) which presents a “keep shopping” button 242, a “view cart” button 243, and a “save/register” button 245. If the user wishes to continue shopping, he or she may actuate the button 242 and return via link 103 to the color palette ordering page 79. Similarly, various “add to cart” selections via links 107, 108, 109 lead to an add to cart confirmation page 232 which provides “view cart” and “keep shopping” buttons 247, 249. If the user actuates button 243 or 247 he is provided with a display of the contents of the shopping cart via page 233, an illustrative embodiment of which is shown in FIG. 14.

On the shopping cart page 233, the user may select to check out via link 119, to keep shopping via link 105, or to view various suggested additional items to purchase via link 115, such as fan decks, brochure packs and designer kits, which may be then added to the cart via respective “add to cart” buttons as illustrated in FIG. 3. The user may learn about various suggested items via link 117, e.g. paint samples, swatches, information about ordering, shipping information, Canadian information, and information about primers. Other related items from various vendors may be made available for on-line purchase of various other interior or exterior decorating related items in this manner, including, for example, bushes, masking tape, caulking, drop cloths, sanding and other surface preparation items.

Assuming the user selects the checkout link 119, he may access successive pages 271, 272, 273, 274 (FIG. 3) which present the items in the shopping cart basket on the shopping cart page 233 with thumbnails, a product description and active areas permitting removal of items and/or alteration of the quantity ordered. These pages provide the user with the ability to select among various billing and shipping options, to review the order, and to finally pay for the items, e.g. by credit card. Acceptance of the user's credit card links to the “Thank You” web page 269, while declination of the card causes appearance of the “card not accepted” page 271. If the credit card is declined, the user may submit another credit card, for example, by activating a “try again” button. The user may optionally save the project or respond “no thanks” on page 269, which returns via link 113 to the Explore Color landing introductory pages. The user may optionally provide personal information via a register page 273 and then return via link 111 to the Color Shop landing page 23.

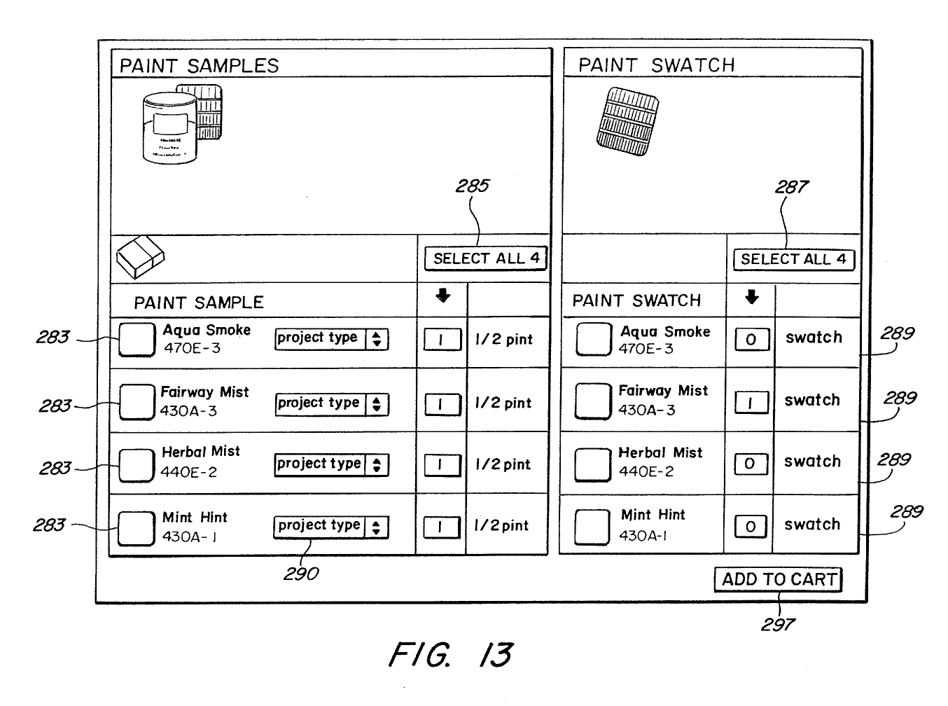

FIG. 13 illustrates details of an illustrative color sample order page, which may provide functions such as those provided by pages 83, 230, of FIGS. 1A and 2B respectively. The page of FIG. 13 includes four lines for four respective colors 283, each identified by color chip, color name and color number. The “project type” drop down list presents the sheen type for the applicable paint sample, either interior flat enamel or exterior flat. Quantity boxes provide for selecting the quantity of paint samples and paint swatches 289 to be ordered. “Select All” buttons 285, 287 are provided for customer convenience. A “learn about” function may be provided to provide more details regarding paint swatches, paint samples ordering and recommended primers.

Part or all of the shopping cart functionality illustrated in FIGS. 1A-3 may be hosted by another website. In such case, customer order details, billing information, shipping information and credit card information may be automatically transmitted for processing by the host. Such transmission is preferably seamless and transparent to the user. The shopping cart host may then transmit the order data to a fulfillment center to actually fill the user's order with the selected products and provide or deliver the ordered items to the user.

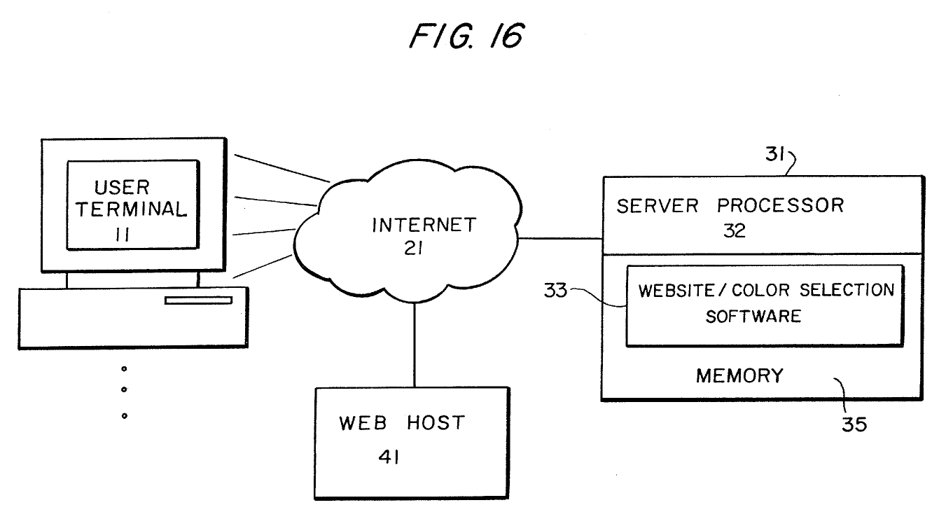

An illustrative hardware environment wherein methods according to the invention may be practiced is shown in FIG. 16. The apparatus of FIG. 16 includes a plurality of end user terminals 11, a server 31 and a web host site 41 providing, for example, shopping cart services. The server 31 includes a computer processor 32, which runs color selection/coordination application and website software 33 stored in memory 35. The user terminals 11, web host 41, and server 31 may communicate with one another in various well-known manners over the Internet 21. Any number of user terminals 11 may exist provided at, for example, home, business or other user sites.

Many alternative embodiments to that of FIG. 16 may be employed in practicing methods according to the invention. For example, the processing provided by the server 31 may be distributed at various locations and may include the functions provided by the web host server 41. The memory 35 may be a single storage unit or distributed across various memory storage devices. Various components of the apparatus may communicate with one another over hardwired or wireless interconnections via means other than the Internet, which interconnections are well-known to those skilled in the art, for example, such as local area networks (LAN) or wide area networks (WAN).

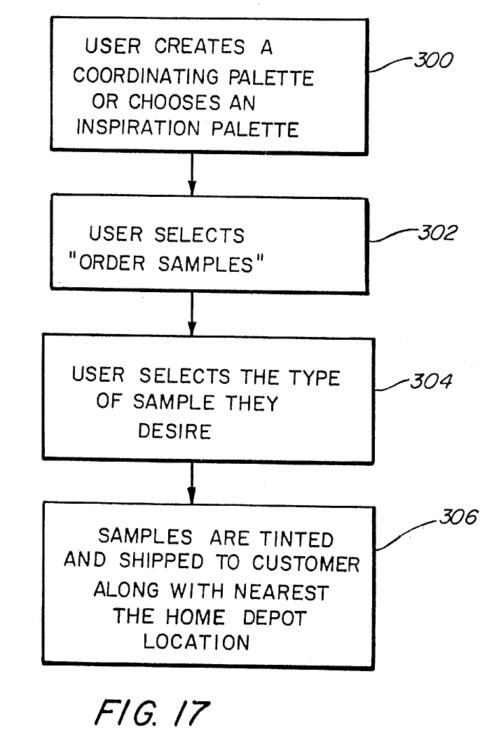

FIG. 17 shows steps of an illustrative color validation process. In particular, in step 300 the user creates a coordinating color palette or chooses an inspiration color palette. The user then proceeds to select and order samples link, step 302. The user then selects the type of sample desired, step 304, whereafter, the samples are shipped to the customer, optionally with the address of a nearby fulfillment center, such as, for example, Home Depot.

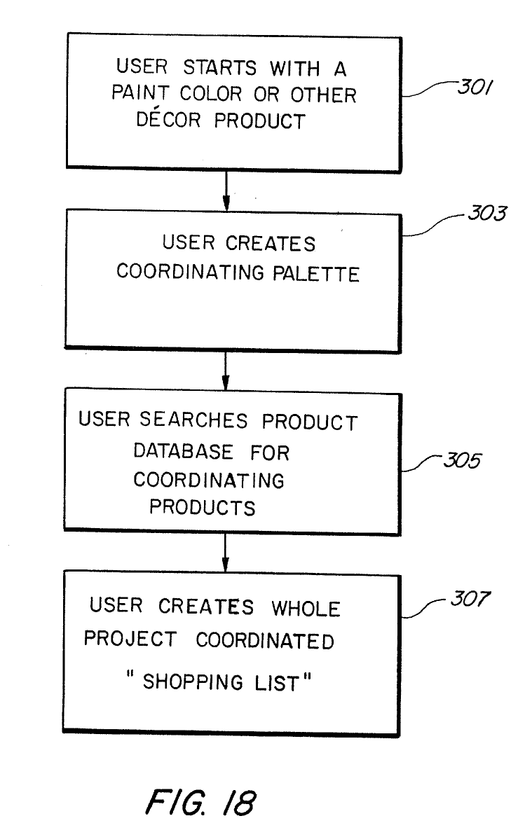

FIG. 18 illustrates steps in another process implementable in the environment of FIGS. 1A-3. In this process, user starts with a paint color or other décor product of interest, step 301. The user then creates a coordinating palette of colors which match the starting color, step 303. The user then searches a product database for coordinating decorative products, step 305. Finally, the user creates a coordinated “shopping list” for the entire project, step 307.

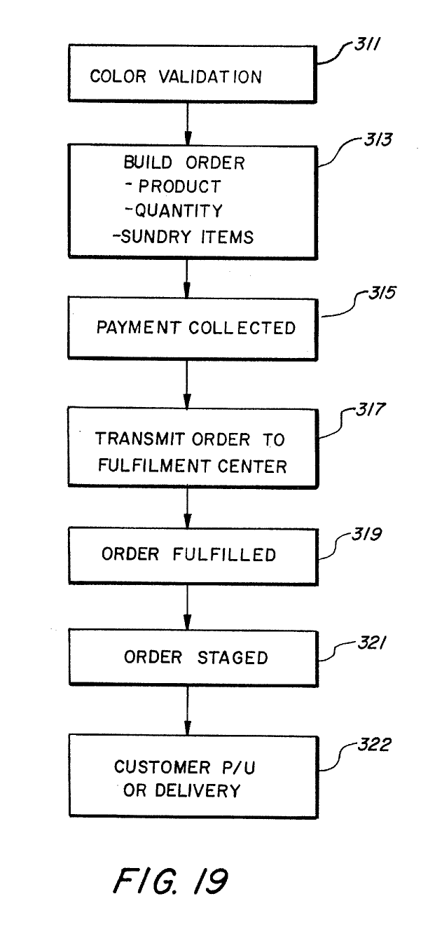

FIG. 19 illustrates steps in project fulfillment according to an exemplary embodiment. In step 311, the user has selected and validated colors to be used in the project and then builds an order of various selected products in selected quantities together with related decorative items in step 313. After the order is built, payment is collected step 315, the order is transmitted to a fulfillment center, step 317, where the order is fulfilled, step 319. The order is then staged, step 321, for customer pick up and/or delivery step 322.

### Color Section and Coordination

The color selection application 80 of FIG. 1B may provide a color selection and coordination system, for example, via a data-driven color model. In the context of the color coordination system, the color model preferably captures the processes associated with color (e.g., color palette coordination, computing shades and tints, etc.), the state of a user's palettes, and represents the set of colors that comprise the color palette.

In the following description, certain terminology is used to describe certain features of one or more embodiments. For instance, the term “color coordination” refers to any system, method, data structure or model, software, and/or device that provides a set of colors that is in harmony with, complements, and/or is aesthetically pleasing when combined with, a starting color. The terms “starting color” and “core color” are interchangeably used to refer to any color that may be selected or provided by a user to coordinate around. The term “hue” refers to the angle of the color when mapped into color space; hue ranges from 0-360 degrees. The term “triad” refers to a color approximately 120 degree from the core color (hue). The terms “complement” or “complementary”, such as complementary colors, refers to a color approximately 180 degree from the core color, such that complement plus core equals white. The term “analogous” color refers to a color with a slightly different hue angle but belonging to the same general color area in color space. The term “shade” is a relative term meaning darker color but otherwise similar hue and relative chroma. The term “tint” is a relative term meaning lighter color but otherwise similar hue and relative chroma. The term “color family” refers to colors within a hue range of about 4 to 8 degrees. The term “accent”, in painting, refers to a color used to add an interesting splash to a room but is not used consistently across the room. An accent color may be used across the room through other decorative items such as fabrics, etc. In exteriors, doors are often treated as accents. The term “trim”, in painting, includes baseboards, windows, crown molding, and fascia boards. A trim color often contrasts with a core color in lightness value and/or hue. The term “depth” is another term for “lightness”. The term “warm”, such as a warm color or triad, refers to colors that can be associated with fire, such as reds, oranges, and yellows. The term “cool”, such as a cool color or triad, refers to colors that can be associated with water, such as blues and greens. Generally, colors that are more green than yellow are cool (and vice versa) and colors that are more red than blue are warm (and vice versa).

In one implementation of the expert color coordinator a real-time color model may be used where coordination of colors, shades and tints are computed in real-time using the principles of color theory. The colors may also be constrained to the limited colors available in the color palette. However, a real-time approach is limited because it doesn't allow for non-color-theory derived palettes and requires that the color coordination application incorporate and execute the color calculations required to derive the appropriate palettes and corresponding colors every time. Such computationally intensive expert color coordinator may be undesirable in certain situations, such as when implementing the system on a server for Internet users or when processing capabilities are limited.

In another embodiment of the color coordinator, a data-driven color model is implemented in which it isn't necessary to compute color values in real-time because the color palette is composed of a finite set of colors, which, in combination with color-coordinating palettes, shades, and tints, can be pre-calculated and stored in a database. A data-driven color model provides the greatest degree of flexibility and ease of use in implementing an automated color coordination coordinator. A color coordination application need not execute and compute color values in real-time but instead simply query a database. Additionally, this allows for non-color-theory derived palettes to be incorporated into the color coordinator's color model with no change to the application program design. That is, since the color coordination relationships are defined as data, color coordination relationships from non-color-theory derived palettes may be entered into the database.

Tables 1-7 below illustrate how a data-driven color coordination system may be implemented using various data structures according to one implementation of the invention. Such data-driven color-coordination system may be employed in implementing one embodiment of the expert color coordinator described above. In one implementation of the color coordinator, a color database is maintained which contains every color available to the user.

For each color in the color database, a table or data element (e.g., Table 1) containing the elements shown is generated. The color palette may include both standard colors (e.g., those colors which are part of a paint product line) as well as user-defined colors (e.g., from user color samples, etc.). The fields Color_id and Name serve as color identifiers. The field Source_id is a reference to the source in which the color can be located, such as the inspiration library color palette, a user-defined color palette, etc. The field L_value describes the luminosity of the color. The fields A_value and B_value identify the color coordinates for particular color in a three-dimensional color model, C_value identifies the color's chroma, and H_value identifies the color's hue. The fields Next_lighter_id and Next_darker_id identify the color in the database which is lighter and darker, respectively, than the current color. Similarly, the fields Next_chroma_id and Prev_chroma_id identify the color in the database which is more muted and less muted, respectively, than the current color. The fields Next_hue_id and Prev_hue_id identify the colors found in the database which are, respectively, next in the color spectrum or preceding in the color spectrum from the current color. Additionally, one or more fields may integrate human expertise into the color database. For example, the field Is_wall_color_only indicates whether the current color and the field Is_offensive may indicate whether the current color is not well suited as an interior or exterior wall color. Such fields may be based on human experience and aesthetic tastes which may not be reflected using just a color theory.

TABLE 1

| Field Name | Description | Type |
|---|---|---|
| Color_id | The primary key for a paint color. This may | CHAR(6) |
| | corresponds to a color code in a color sample or | |
| | swatch (e.g. standard color codes for a paint product | |
| | line, or a user-provided color sample) | |
| Name | The display name for this color | VARCHAR(60) |
| Source_id | A reference to the source from which the color can | CHAR(6) |
| | be located (e.g. Color Center, Interior Collection, | |
| | user-defined color, etc.) | |
| L_value | The decimal value for the luminosity of the color. | DECIMAL(6, 3) |
| A_value | The decimal value for the ‘a’ coordinate of the color. | DECIMAL(6, 3) |
| B_value | The decimal value for the ‘b’ coordinate of the color. | DECIMAL(6, 3) |
| C_value | The decimal value for the chroma of the color | DECIMAL(6 3) |
| H_value | The decimal value for the hue of the color. | DECIMAL(6, 3) |
| Next_lighter_id | Foreign Key to a Paint Color that is the | CHAR(6) |
| | corresponding next lighter version of this Paint | |
| | Color. In most cases this will be the Paint Color | |
| | whose C_Value and H_Value are the same but whose | |
| | L_Value is greater. | |
| Next_darker_id | Foreign Key to a Paint Color that is the | CHAR(6) |
| | corresponding next darker version of this Paint | |
| | Color. In most cases this will be the Paint Color | |
| | whose C_Value and H_Value are the same but whose | |
| | L_Value is less. | |
| Next_chroma_id | Foreign Key to a corresponding Paint Color that is | CHAR(6) |
| | more muted. In most cases this will be the Paint | |
| | Color whose L_Value and H_Value are the same but | |
| | whose C_Value is less. | |
| Prev_chroma_id | Foreign Key to a corresponding Paint Color that is | CHAR(6) |
| | less ‘muted’. In most cases this will be the Paint | |
| | Color whose L_Value and H_Value are the same but | |
| | whose C_Value is greater. | |
| Next_hue_id | Foreign Key to a corresponding Paint Color that is | CHAR(6) |
| | next in the color spectrum. In most cases this will be | |
| | the Paint Color whose L_Value and C_Value are the | |
| | same but whose H_Value is greater. | |
| Prev_hue_id | Foreign Key to a corresponding Paint Color that is | CHAR(6) |
| | preceding in the color spectrum. In most cases this | |
| | will be the Paint Color whose L Value and C Value | |
| | are the same but whose H_Value is less. | |
| Is_wall_color_only | Boolean value that indicates that this color may only | BOOL |
| | be used as a wall color and not as an accent or trim. | |
| Is_offensive | Boolean value that indicates that the color is | BOOL |
| | ‘offensive’ as an interior and/or exterior wall color. | |

In the color select and coordination system, color refinement is the process of navigating a color palette in a manner that is intuitive to a user. To that end, a fine-tune (refine or modify) color interface (e.g., 1006 or 1018 in FIG. 10) may provide such functionality in a series of buttons that allow the user to indicate what the next color to view. This may be accomplished by specifying relationships between the colors in the color database. These relationships may be specified for each color in the color database using the data structure or table illustrated in Table 1 where the previous and next color for various different characteristics (e.g., L_value, A_value, B_value, C_value chroma, H_value, Next_lighter_id, Next_darker_id, Next_chroma_id, Prev_chroma_id, Next_hue_id, and Prev_hue_id) are identified. For example, a fine-tuning interface may include a “More Muted” button, which, when pressed, presents the user with a database color that is more muted than the color currently being viewed. Similarly, other buttons, such as “less muted, lighter, darker, may be available to refine a color.

The colors in the color database are intended to be displayed on a display screen or printed for the user's convenience. Since many of the display devices (e.g., monitors) and printers employ a combination of a basic colors (e.g., three colors—red, green, and blue) to generate all other colors, having a ready conversion between the colors in the color database and said basic colors would be advantageous and expedite processing. For every paint color in the color database, the color coordinator system needs to be able to render a digital equivalent on screen. Fore example, colors displayed on a display screen may be expressed in terms of red, green, and blue (RGB) values. These RGB values may be stored in a database in a separate table (e.g., Table 3 below) and identified by corresponding kiosk and paint color.

The reason RGB values are not stored directly in the paint color table (e.g., Table 1) is due to the fact that although RGB values can be derived from the values (e.g., L_value, A_value, B_value, C_value, and H_value) stored in the paint color table (e.g., Table 1), they often run the risk of not being visually accurate for every monitor. Various factors impact the visual accuracy of a color expressed on a display monitor such as ambient lighting, temperature, etc. The adjustment of the RGB values to compensate for specific monitors is referred to as calibration.

Calibration is the process of generating a color profile which is used by an application (e.g., the color coordination system) to compute appropriate RGB values for a specific environment (e.g. display monitor, printer, etc.). Unless the color profile changes (as a result of re-calibration), RGB values can be pre-computed and stored in the database for each monitor/paint color combination to prevent the need to evaluate RGB values in real-time. According to one embodiment of the invention, such conversion values (e.g., RGB values) are generated for each color in the database and for each display and/or printing device that may be attached to a kiosk.

Table 2 illustrates how calibration or conversion data/values may be arranged and stored in a conversion table for each color in the color database. Such conversion or calibration tables represent a unique color profile for the devices in the kiosk (e.g., printer, display device, etc.). The field Color_id identifies the color in the database to which the conversion data applies. The field Kiosk_id identifies the kiosk device (e.g., display device, printing device, etc.) to which the conversion data applies. According to one embodiment of the invention, three basic colors are used to generate all other colors in the color database. For example, the colors red, green, and blue are used in the data structure illustrated in Table 2. The fields R_value, G_value, and B_value provide the amount of red, green, and blue, respectively, that should be mixed to generate the corresponding color in the color database. In other implementations of the invention, more or fewer basic colors may be used without deviating from the invention.

TABLE 2

| Field Name | Description | Type |
|---|---|---|
| Color_id | Foreign Key to a corresponding Paint Color. | CHAR(6) |
| Kiosk_id | Foreign Key to a corresponding Kiosk Element. | CHAR(6) |
| R_value | The decimal value for the RED component | Decimal |
| | of the corresponding Paint Color. | (6, 3) |
| G_value | The decimal value for the GREEN component | Decimal |
| | of the corresponding Paint Color. | (6, 3) |
| B_value | The decimal value for the BLUE component | Decimal |
| | of the corresponding Paint Color. | (6, 3) |

Another aspect of the data-driven color model provides a data structure or table (e.g., Table 3) for color palettes. A color palette may be defined as a combination of grouped colors. Palettes may be generated according to and grouped into schemes. For example, color palettes for Monochromatic, Complementary, Warm, and Cool color schemes may be stored. Additionally, custom schemes may be generated and stored by users or others.

In one embodiment of the invention, a palette may be represented as a data structure in which each paint color in the palette is identified with a corresponding surface/location to be painted.

For example, Table 3 illustrates a data structure of a paint color palette according to one embodiment of the data-drive color model invention. The field Palette_id provides a unique identifier for the palette. The field Display_name identifies the palette by a name that may be displayed to the user of the color selection and coordination system. The fields Wall_color_id, Accent_color_id, and Trim_color_id, identifies the colors that may be used along the walls, accent surfaces, and trims, respectively. The field White_color_id identifies the white color that may be used along with the other colors in the palette.

TABLE 3

| Field Name | Description | Type |
|---|---|---|
| Palette_id | The Primary Key for the Palette. | CHAR(6) |
| Display_name | The display name for the palette | VARCHAR(60) |
| Wall_color_id | Foreign Key to a corresponding | CHAR(6) |
| | Paint Color that will be the | |
| | wall color. | |
| Accent_color_id | Foreign Key to a corresponding | CHAR(6) |
| | Paint Color that will be the | |
| | accent color. | |
| Trim_color_id | Foreign Key to a corresponding | CHAR(6) |
| | Paint Color that will be the | |
| | trim color. | |
| White_color_id | Foreign Key to a corresponding | CHAR(6) |
| | Paint Color that will be the | |
| | white color. | |

According to one implementation of the color coordinator, once the user has selected a starting or core color, the color coordinator accesses the color database and provides a plurality of color combinations. In various embodiments of the invention, a color combination is a coordinating color combination that may be dynamically determined or predetermined. For example, four color schemes may be provided to the user. Each of the four color schemes or palettes may be related to a separate color coordination algorithm. Tables 4-7 illustrate four color palettes that may be provided to the user.

Table 4 illustrates a monochromatic scheme in which colors selected for the Trim and Alternate Trim colors are a tint or shade of the core or starting color. The Accent and Alternate Accent colors are analogous colors (slightly different hue angle but belonging to the same general color area in color space) of equal value (chroma, depth). The White color is a white color of similar hue as the core color,

TABLE 4

| Term | Description |
|---|---|
| Core Color | The color the user has chosen to coordinate around. |
| Trim | If core is dark, tint of core. If the core is light, |
| | then it's a shade of the core. |
| Accent | Analogous color of equal value (chroma, depth) |
| White | White of similar hue as core |
| Alt Trim | Shade or tint of core |
| Alt accent | Analogous color of equal value on the opposite side of |
| | core than the accent |

Table 5 illustrates a complementary color scheme in which complementary colors are those colors approximately one hundred eighty (180) degrees from the core or starting color. The Trim color is a complementary color of equal value to the core color and the Alternate Trim color is a color which is a shade or tint of the complementary color of the core color. The Accent color is a color that is a tint or shade of the core color and the Alternate Ascent color is a color that is a tint or shade of the core color with more contrast. The White color is a white color of similar hue as the core color.

TABLE 5

| Term | Description |
|---|---|
| Core Color | The color the user has chosen to coordinate around. |
| Trim | Complement of equal value. |
| Accent | Tint or shade of core color (If light, then dark, if |
| | dark, then light) |
| White | White of similar hue as the core color |
| Alt Trim | Shade or tint of complement |
| Alt Accent | Tint or shade of core color with more contrast |

Table 6 illustrates a warm triad scheme in which the colors are approximately 120 degree from the core color (on warm side of the hue). The Trim color is a Triad color (on warm side of hue) of equal value and the Alternate Trim is a color which is a shade or tint of the triad (on warm side of hue). The Accent color is a color a tint or shade of core color and the Alternate Ascent color is a tint or shade of the core color with more contrast. The White color is a white color of similar hue as the core color.

TABLE 6

| Term | Description |
|---|---|
| Core Color | The color the user has chosen to coordinate around. |
| Trim | Triad (on warm side of hue) of equal value |
| Accent | Tint or shade of core (If light, then dark, if dark, then light) |
| White | White of similar hue as core color |
| Alt Trim | Tint or shade of triad (on warm side of hue) |
| Alt Accent | Tint or shade of core with more contrast |

Table 7 illustrates a cool triad scheme in which the colors are approximately one hundred twenty (120) degrees from the core color (on cool side of the hue). The Trim color is a Triad color (on cool side of hue) of equal value and the Alternate Trim is a color which is a shade or tint of the triad (on cool side of hue). The Accent color is a color that is a tint or shade of core color and the Alternate Ascent is a color that is a tint or shade of the core color with more contrast. The White color is a white color of similar hue as the core color.

TABLE 7

| Term | Description |
|---|---|
| Core Color | The color the user has chosen to coordinate around. |
| Trim | Triad (on cool side of hue) of equal value |
| Accent | Tint or shade of core color (If light, then dark, if |
| | dark, then light) |
| White | White of similar hue as core color |
| Alt Trim | Tint or shade of triad (on cool side of hue) |
| Alt accent | Tint or shade of core with more contrast |

Another aspect of the invention provides for generating the necessary color metrics (e.g., in Table 1, L_value, A_value, B_value, C_value chroma, H_value, Next_lighter_id, Next_darker_id, Next_chroma_id, Prev_chroma_id, Next_hue_id, and Prev_hue_id) for a color provided by the user, for instance, via a spectrophotometer. Thus, a user may add colors to the color database and color palette.

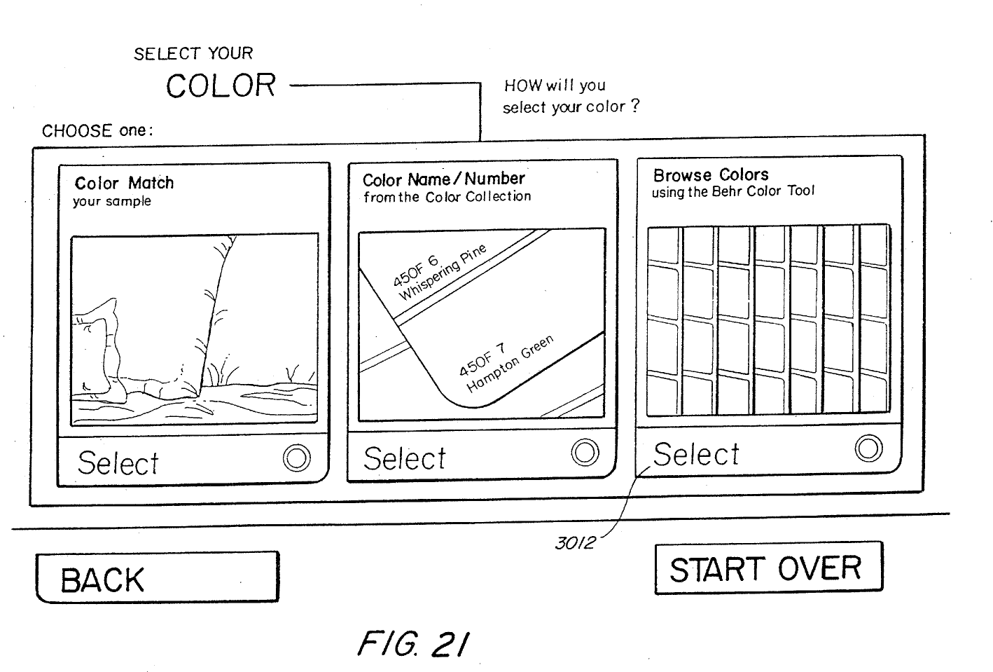

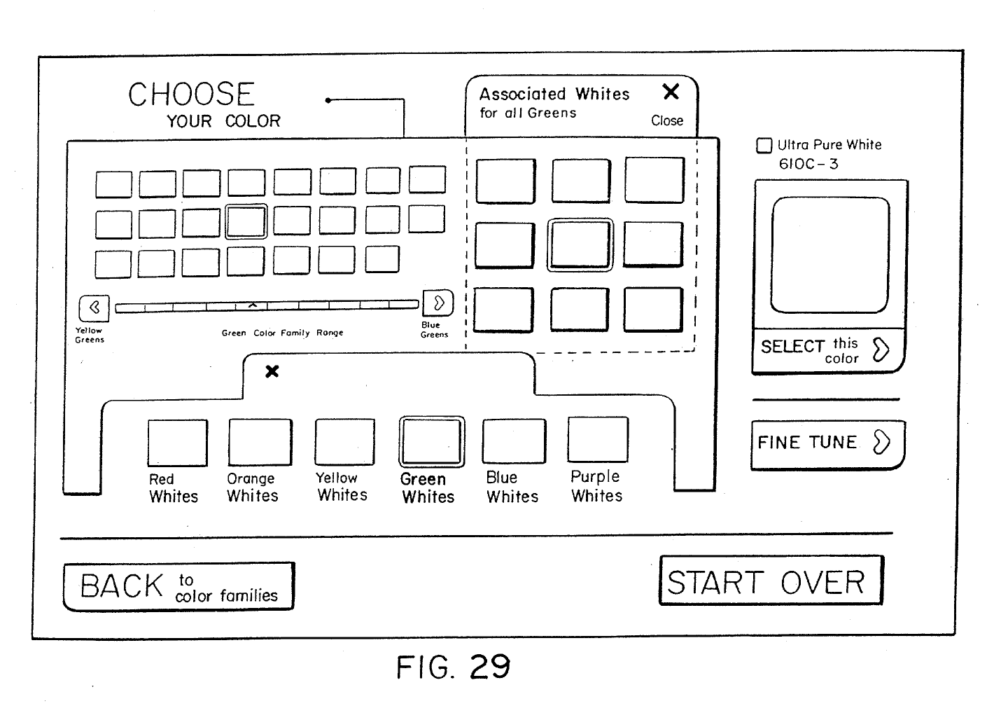

Illustrative screens and functionality of an embodiment incorporating various aspects of a color selection application 80 will now be described in connection with FIGS. 21 to 51. Like the functionality and web pages illustrated in FIG. 1-15, this functionality may be implemented in an application program or software which may be written in, for example, Java, Laszlo Presentation Server, or C++ and, which may run, for example, on a Windows XP or other operating system. The application and/or software is stored on a suitable program storage medium or media and may be based locally, such as in memory located in a kiosk or may be accessed over one or more communication links, such as from a server over the internet. In the following discussion, reference is made to “selection” of various links and other items presented on the screens under discussion. Those skilled in the art will appreciate that such selection may be accomplished with respect to a computer display screen or monitor by various point and click or point and touch operations accomplished by various well-known devices such as, for example, a conventional mouse, track ball or touch sensitive screen.

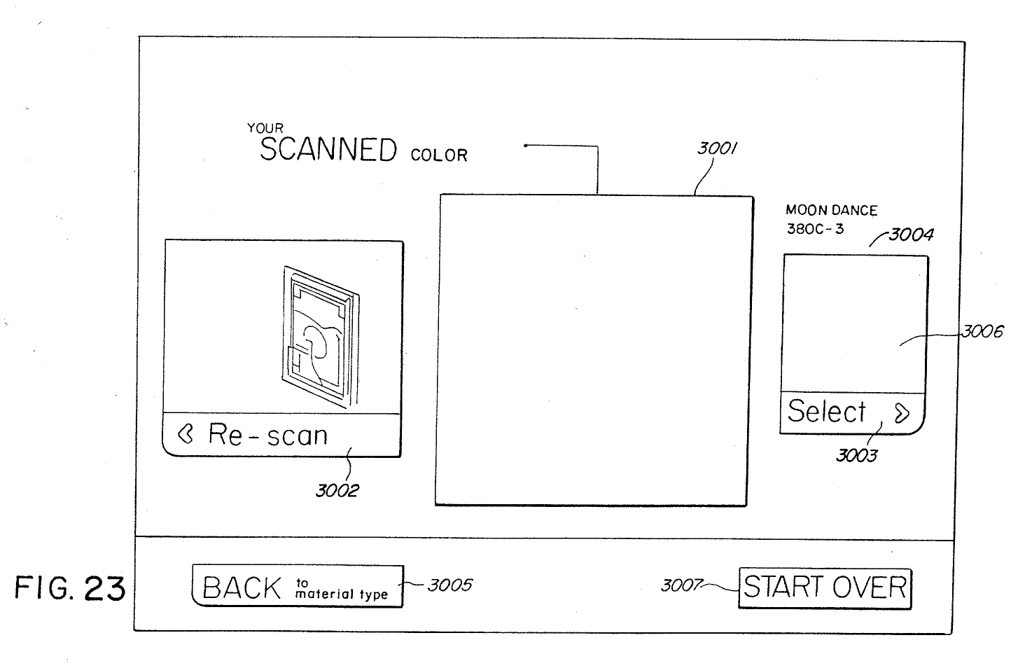

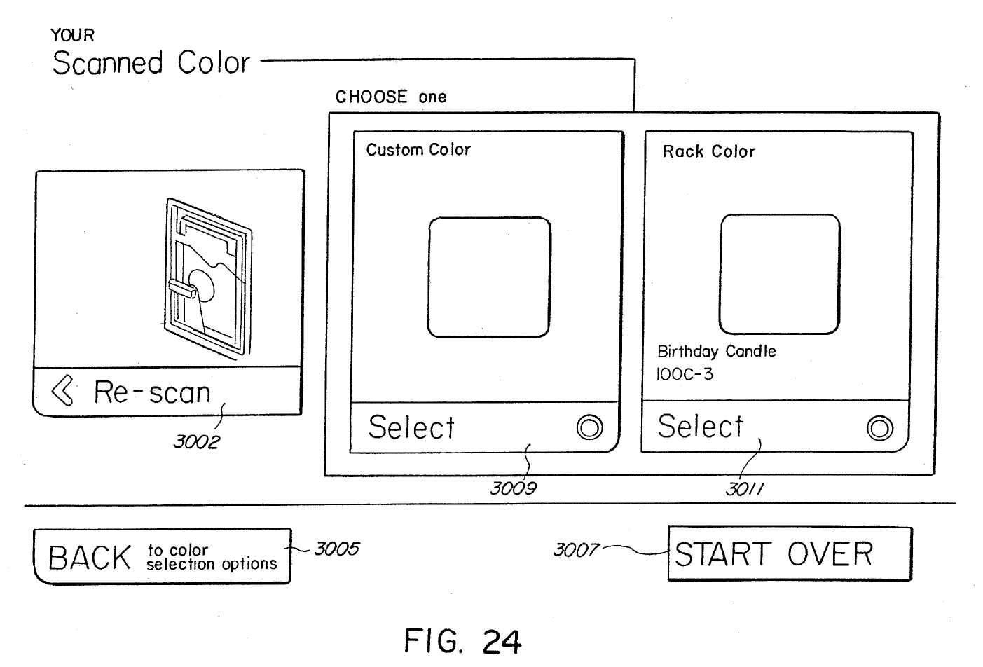

FIGS. 23 and 24 illustrate screens presented after a user has scanned a paint sample to detect its color, for example, using a spectrophotometer or other color sensing device. A user may be permitted to have the system determine a custom color to substantially identically match his or her sample color. Alternatively, the user may select a pre-mixed, off-the-shelf (“rack”) color which, to the user's eye or to the system, is the closest match or otherwise desirable.

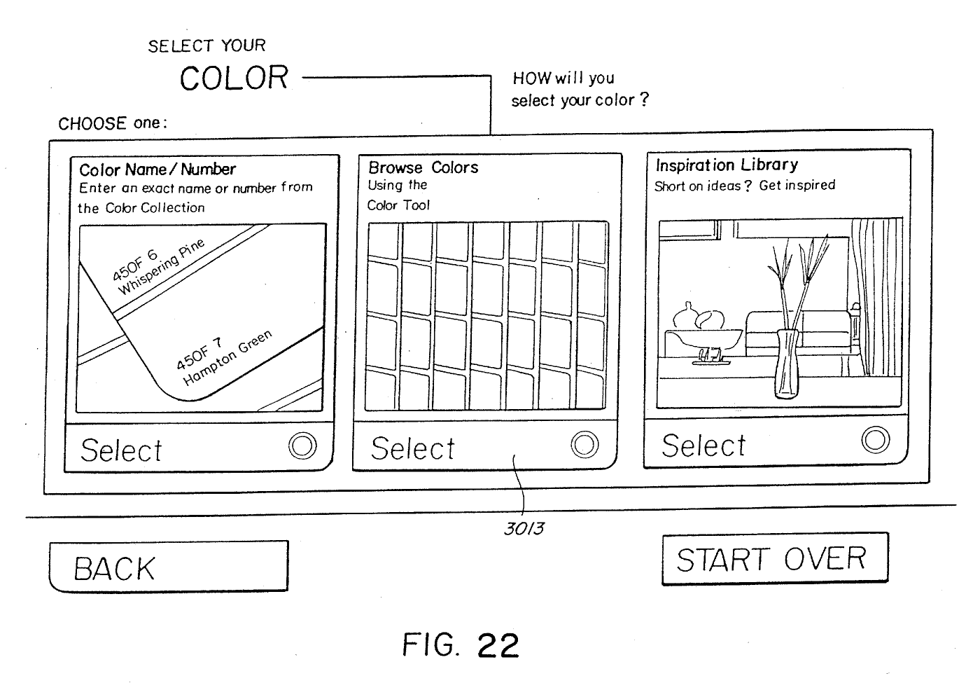

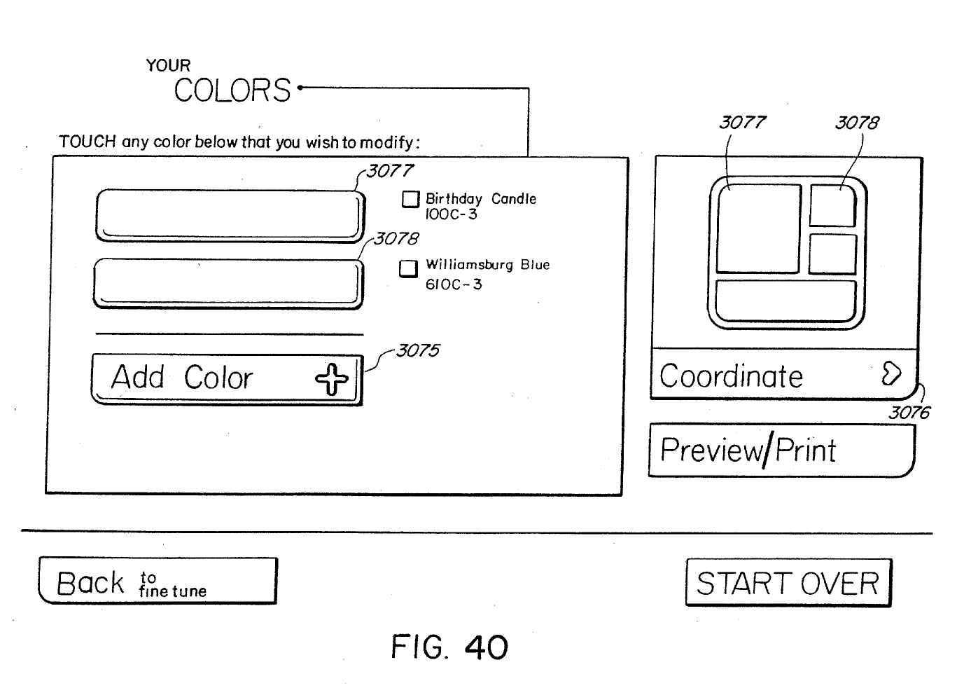

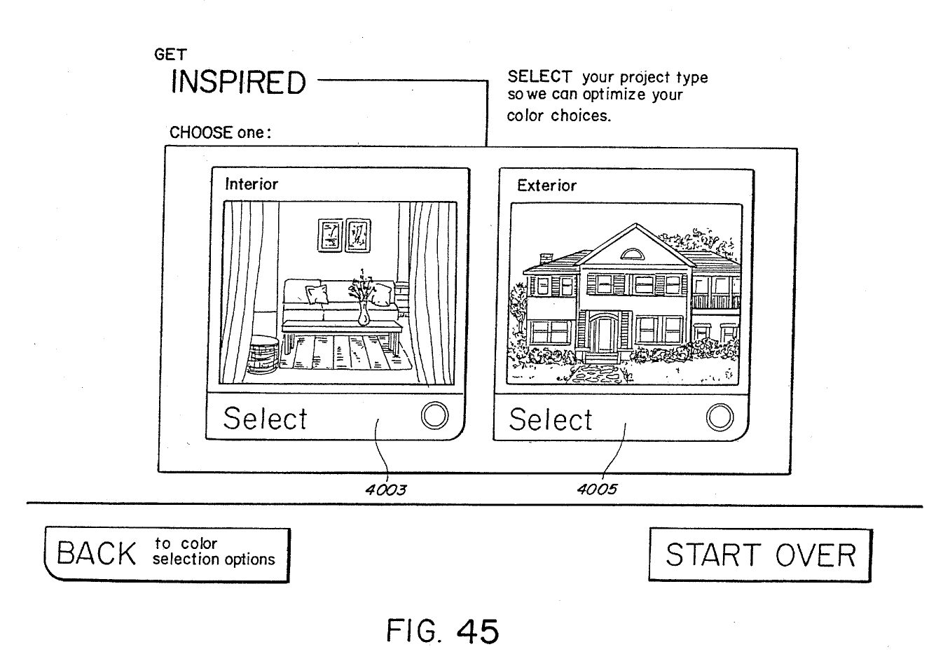

FIG. 23 illustrates a first system state wherein the ability to choose a custom color is disabled or a standard rack color is close enough to the scanned sample color (displayed in box 3001) that a custom color is not offered. In such case, the system presents the closest rack color 3006 in box 3004 and the user selects one of the following links, with resulting action illustrated in angle brackets “< >”.
1. “Select” this color 3006, via link 3003 <go to Coordination/Similar Colors: FIG. 40 page 2>
2. Re-scan, link 3002, <go to initial page of the scan procedure (not shown)>
3. Back, link 3005, <go to previous screen of the scan procedure (not shown)>
4. Start Over, link 3007, <go to initial Start page>
   The initial Start page preferably permits the user to indicate whether he or she already has a color in mind, in which case a screen such as FIG. 21 or 22 is presented, or needs some inspiration or ideas to assist in selecting an initial color, in which case an inspiration library or display is presented, for example as illustrated in FIGS. 45-50.

FIG. 24 illustrates a second system state wherein the ability to choose a custom color is enabled and the user's sample is not close enough to a standard rack color. In such case, the user selects one of the following:
1. “Select this color/I want a custom color”, link 3009, <go to Coordination/Similar Colors: page 2, FIG. 40>
2. “Select this color/I want the nearest rack color”, link 3011, <go to Coordination/Similar Colors: FIG. 40>
3. Re-scan, link 3002, <go to initial page of the scan procedure>
4. Back, link 3005, <go to previous screen of the scan procedure>
5. Start Over, link 3007, <go to initial start page>
   The Application is preferably built so that the custom color component can be turned off at any time by a system administrator by manipulating a properties initialization file.

If the user selects a custom color, then where a standard off-the-rack paint color would be shown in the rest of the application, “Custom Color” is displayed. For example, on FIG. 40, the text “Birthday Candle” would be replaced with “Custom Color” and the text “100 C-3” would be eliminated. No text is displayed where the standard rack color paint code would be displayed.

The system may be configured to prompt a sheen selection, for example, by generating a “Custom Sheen Alert”, such as “Due to custom formula requirements, your scanned color needs a sheen assignment. Please select at least one area for your custom color.” The flow then proceeds to a Custom Color Sheen assignment screen (not shown) that allows users to select an area or areas which they intend to paint to which to assign the custom color, and then goes to an interior and/or exterior sheen assignment screen, as relevant to the choices.

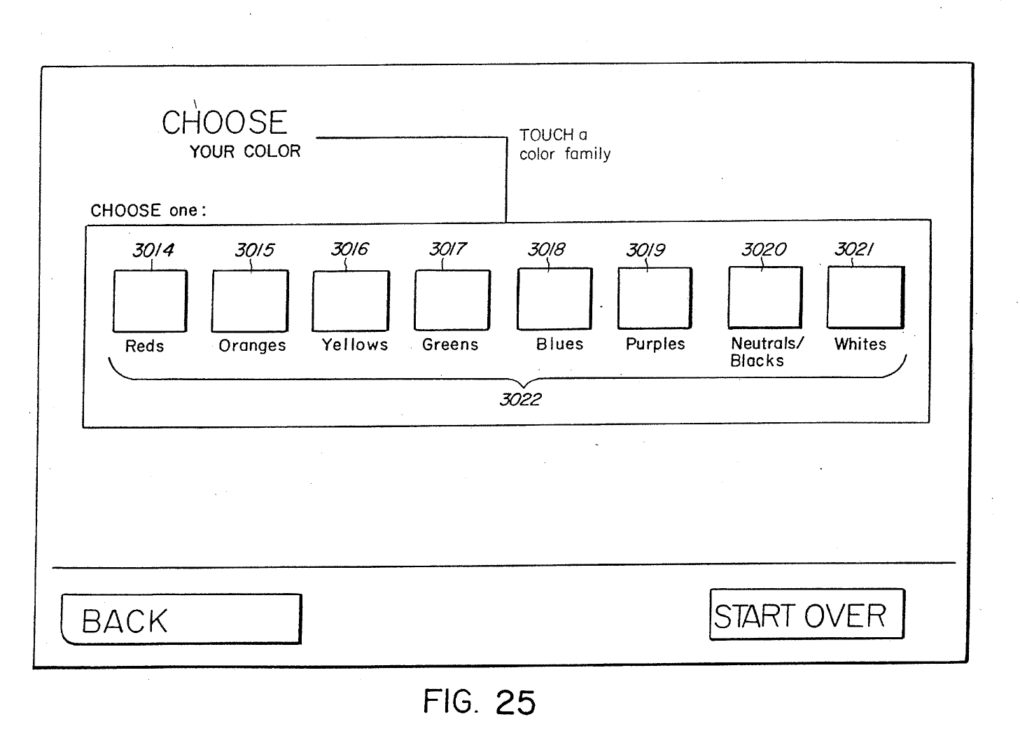

FIGS. 25-37 illustrate screens employed in a preferred “browse” implementation, which permits a user to select from a range of rack colors presented by the system. This “browse” feature may be entered for example via links 3012 and 3013 of FIG. 21 and FIG. 22 respectively.

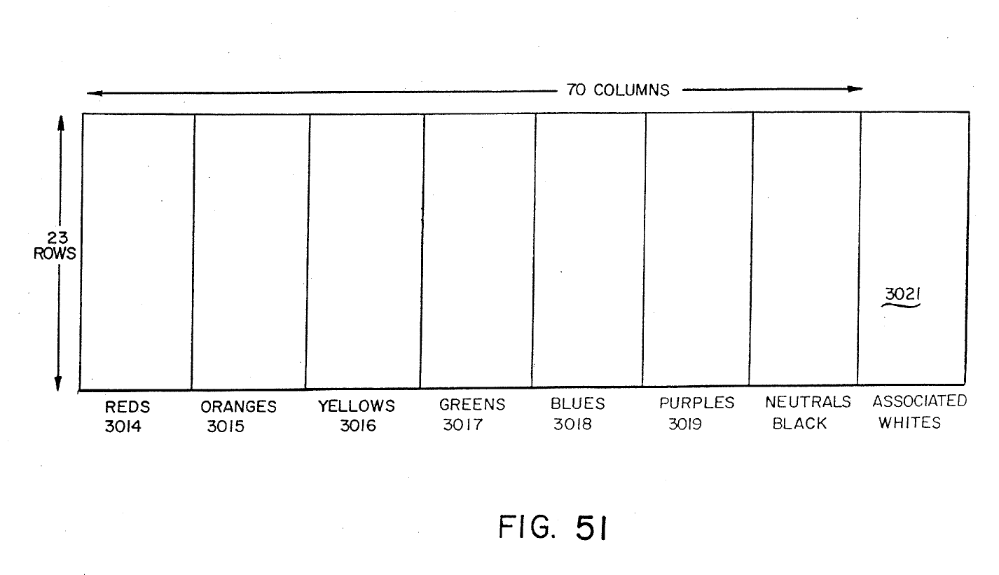

The range of rack colors is preferably stored in a table in memory which may be referenced as a “color selection table.” An example of such a table is illustrated in FIG. 51. The illustrative table of FIG. 51 includes a range of columns of reds 3014, oranges 3015, yellows 3016, greens 3017, blues 3018, and purples 3019 and neutrals/blacks 3020. The number of columns may be 70, for example. The table also includes a matrix of “associated whites” 3021. In a preferred table each column includes 23 colors comprising selected shades of the primary hue. Each of the 23 colors is assigned a unique numerical code for example such as 450, 450A-1, 450A-2, 450A-3, 450B-4, 450B-5, etc. Various coding schemes may be used as known to those skilled in the art.

Various navigations from one color to the next color in the table of FIG. 51 are mapped out in an XML map or data set. For example, if the user is at color 450A-1 and selects a “next shade” link, the XML code directs that the color 450A-2 be selected. A selected set of colors in a column may be referred to as a “card”, analogous to a physical card of a color rack display. A “card” may contain for example, four or five shades of a selected hue.

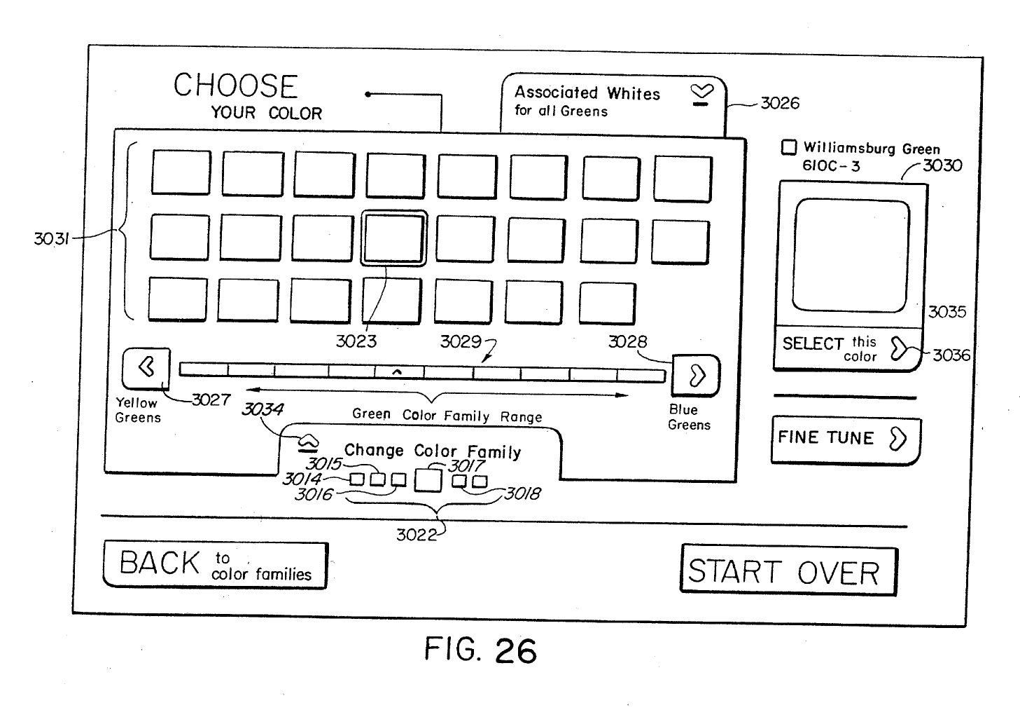

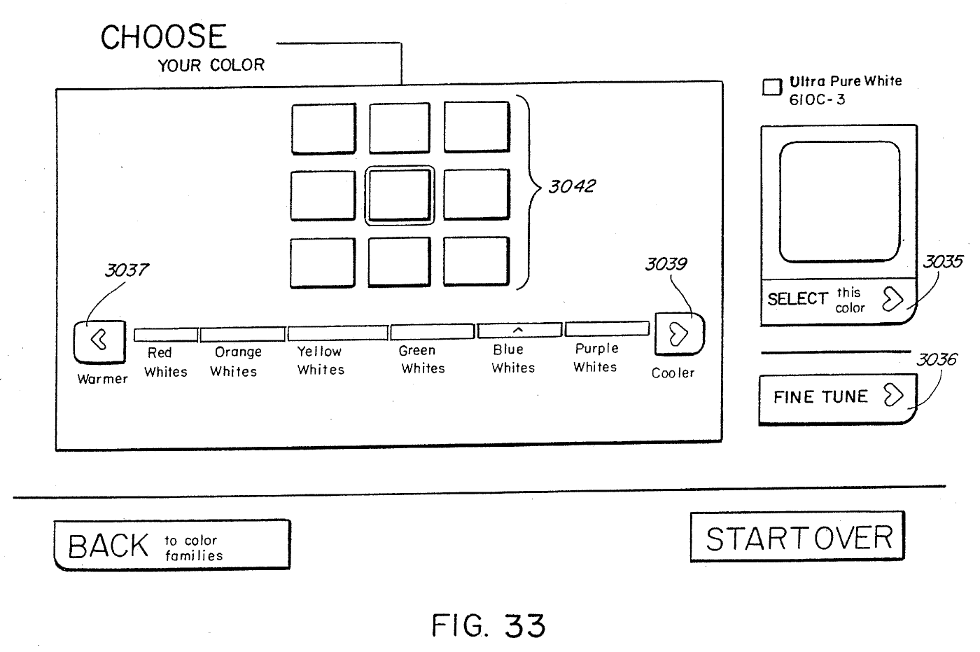

Upon initial entry into the “browse” feature, the user is presented with the screen shown in FIG. 25. Here, the user selects one of the color links for one of a plurality of color ranges: Reds 3014, Oranges 3015, Yellows 3016, Greens 3017, Blues 3018, Purples 3019, Neutrals/Blacks 3020, or Whites 3021. All color links go to the Browse: FIG. 26 (page 2), except “Whites”, which go to Browse: FIG. 33 (page 9).

The screen of FIG. 26 is entered via animation from Browse: FIG. 25 page 1. According to the animation, the eight color chips 3022 slide to the bottom of the screen in FIG. 26 to become the “Change Color Family” slider. FIGS. 25 and 26 particularly illustrate selection of “greens” 3017. Upon initial entry, the user is shown the 23 colors 3031 for the selected hue, in this case, 23 shades of green. No color is pre-selected, however, a rectangular bar element 3023 located mid-screen and representing a default color is highlighted. If a user selects one of the 23 colors 3031, the selected color rectangle is highlighted on the display.

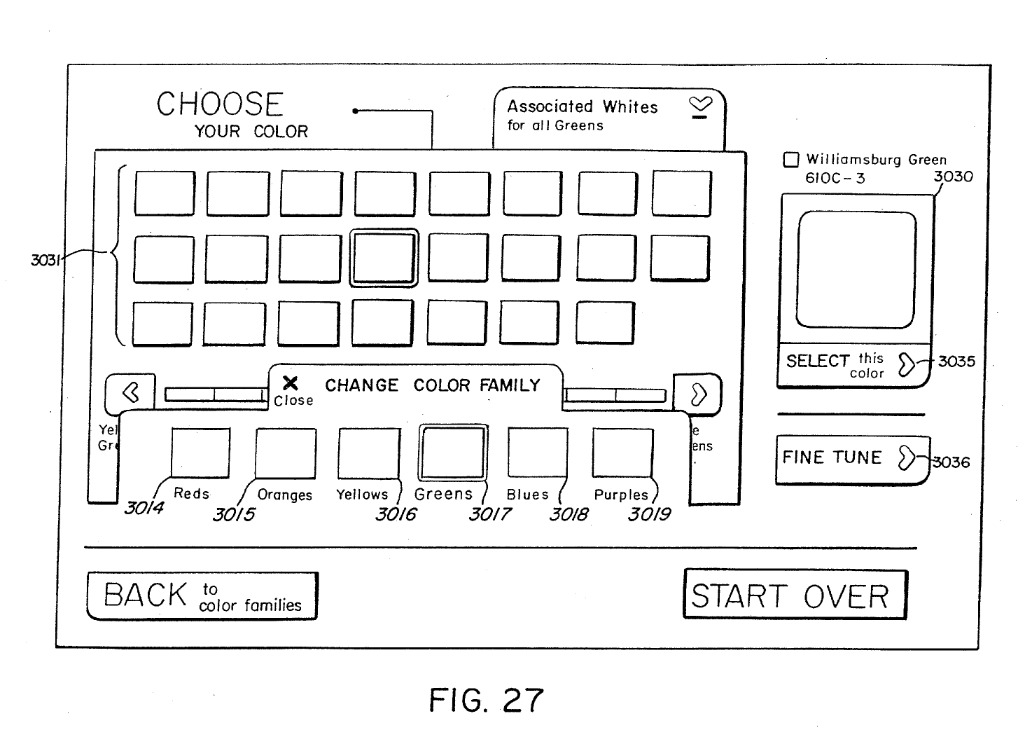

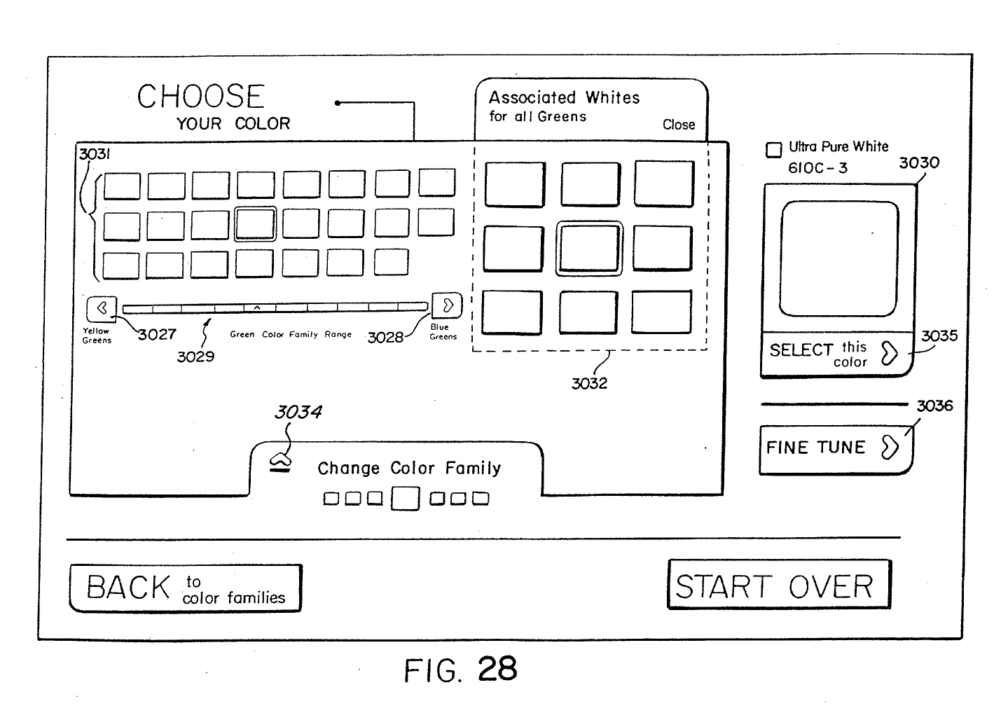

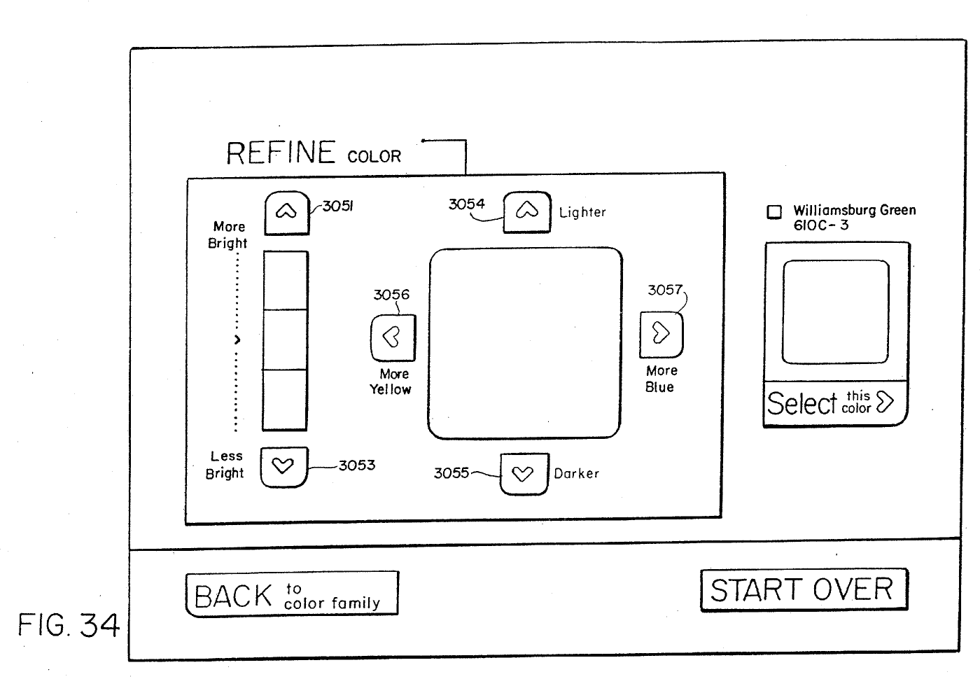

The functionality of various links presented by the screen of FIG. 26 are:
Associated Whites 3026 <go to Browse: FIG. 28 page 4>
If the user selects the left arrow 3027 or right arrow 3028 from the mid-page bar 3029, then the page re-loads with the next column of colors displayed as appropriate and with the mid-page bar 3029 highlighted with the newly indicated column
Change Color Family <As shown in FIG. 27, a tab slides up revealing all hues except white and neutrals/blacks; if the user selects a different hue of the group 3022, then the page of FIG. 25 re-loads with the color specified in the XML map>
Select this color 3035 <go to Coordination/Similar Colors: FIG. 40 page 2>
Fine Tune 3036 <go to Browse: FIG. 34 page 10>
Start Over <go to Start page>
Back <go to Browse: FIG. 25 page 1>

If “Associated Whites” 3026 is selected on the screen of FIG. 26 or FIG. 27, the screen of FIG. 28 is displayed. The particular whites displayed are determined by the XML mapping. When the screen of FIG. 28 is displayed, the 23 color buttons 3031 and the related bar 3029 reduce in size and animate (move) left making space for 9 white buttons 3032 to animate in on the right. In this screen, all hue and all white chip links are active and when one is selected, it highlights on the display. No white chip is selected as a default

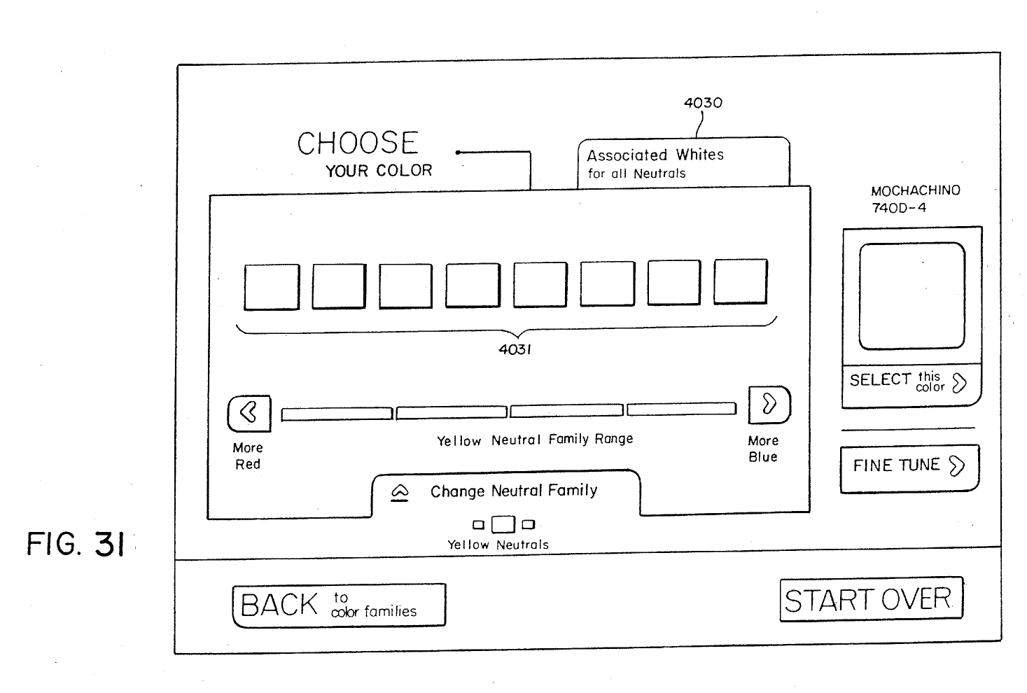

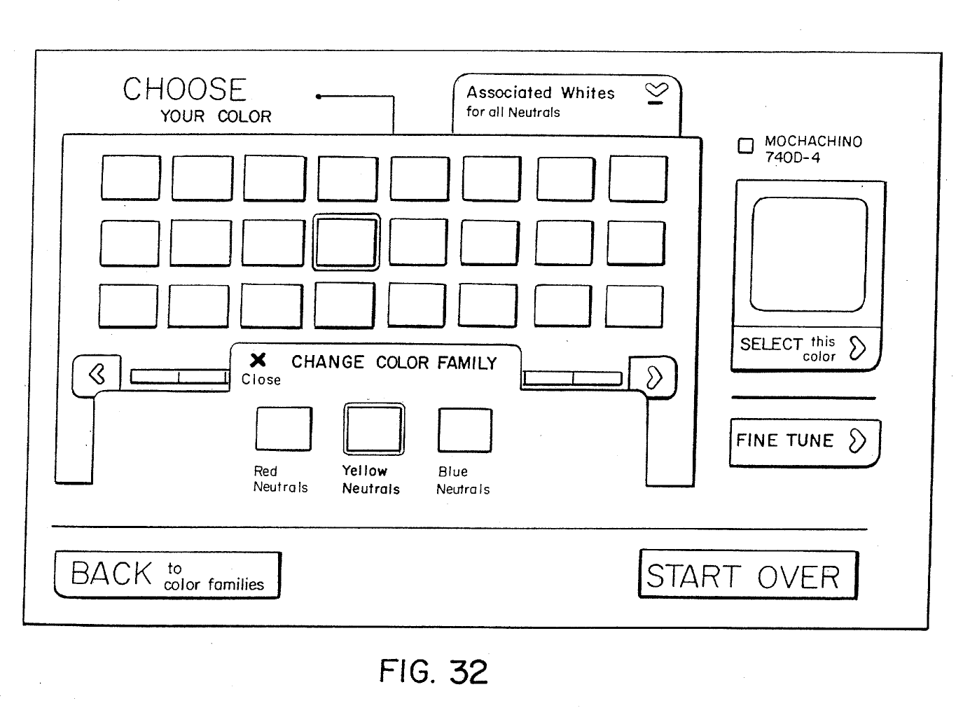

The functionality of various links on the screen of FIG. 28 is as follows:
If user selects the left arrow 3027 or right arrow 3028 from the mid-page bar 3029, then the page re-loads with the next column of colors displayed as appropriate
Change Color Family <tab slides up revealing all hues except white and neutrals/blacks as shown in FIG. 32; if users selects a different hue, then the page of FIG. 28 re-loads with the associated whites of that hue>
Select this color 3035 <go to Coordination/Similar Colors: FIG. 40 page 2>
   The Fine Tune, start over and Back links provide the same functionality as the screen of FIG. 31.

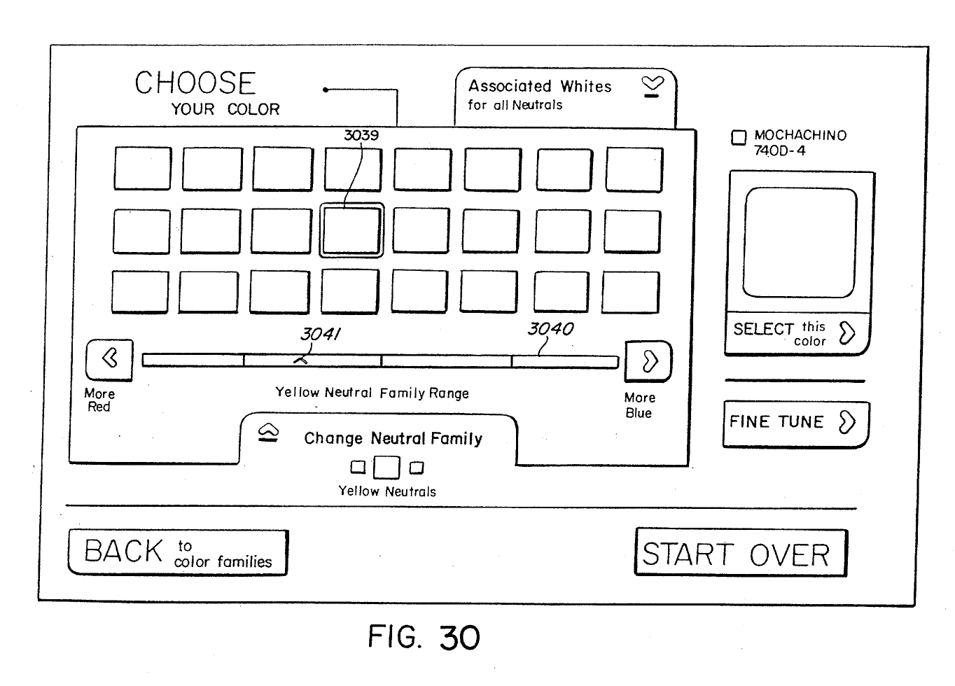

If “Neutrals/Blacks” 3020 is selected on the screen of FIG. 25, the eight color chips 3022 fade away to the display of FIG. 30. Upon entry, the user is shown cards 4, 5 and 6 of yellow neutrals and moves by groups of 3 cards right or left in the color selective table, except card 10 is shown on its own. No chip is selected upon entry, and when a chip is selected, it highlights. The bar element 3039 mid-screen represents where the user is via highlighting—navigation is “more red, etc.” depending on location of the user's selection (not warmer/cooler); a user can traverse the 3 neutral groups through this bar. The bar element refers to the horizontal bar on FIG. 30 flanked by two arrows. A user can navigate from yellow neutrals to blue neutrals to red neutrals (throughout all three neutral families) by continuing to use this bar. An arrowhead indicates the user's location.

FIG. 31 displays how the screen appears when there is only one remaining color for the “yellow neutral” color family. FIG. 32 displays the active state of the “change family bar” when activated from FIG. 30.

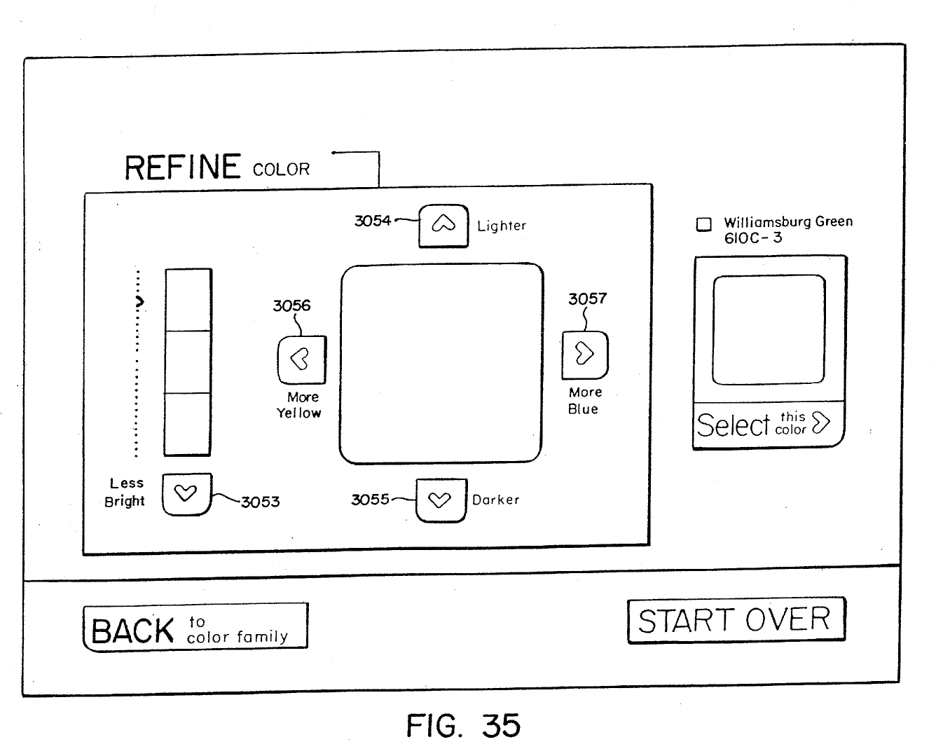

A hue control bar for neutrals may be provided to allow users to move to the red, yellow or blue-based hue, depending on their location. The hue control bar is the larger bar in FIG. 35 with text “Change Neutral Family”, which, when activated, looks like FIG. 32. The functions of the Select this color, Fine Tune, Start Over, and Back links on the screen of FIG. 30 are the same as in FIG. 26.

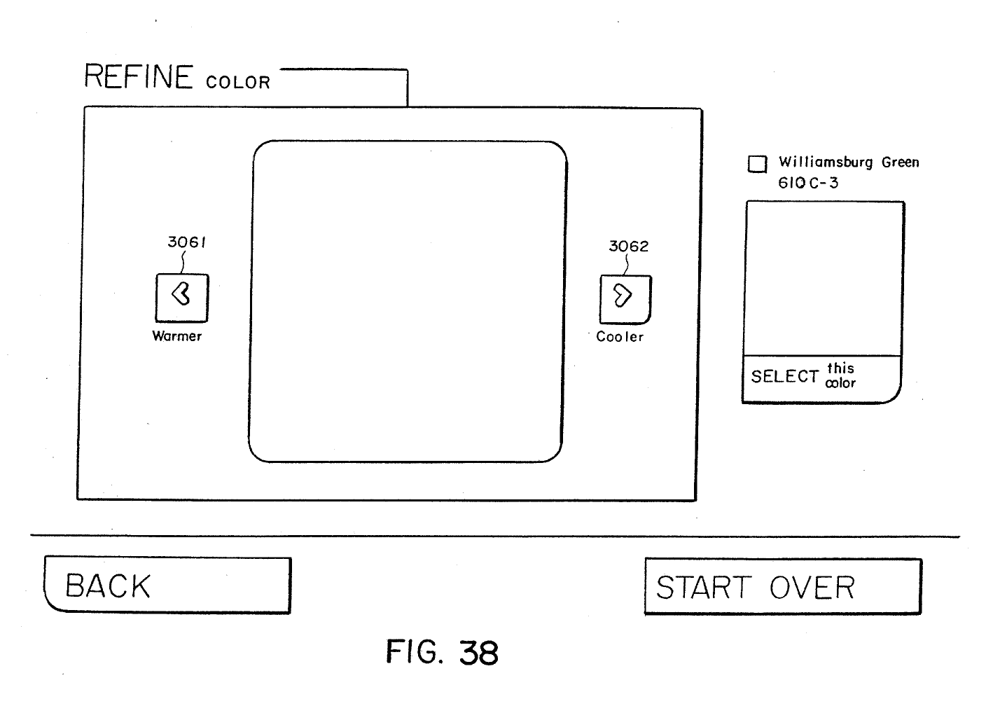

If “Whites” 3021 is selected on the screen of FIG. 25, the eight color chips (3022) fade away into the display of FIG. 33. The functionality of various links of FIG. 38 is as follows:
Upon entry: User defaults to the 9 whites for the blue hue because in the illustrative embodiment under discussion the “whitest” white is “Ultra Pure White”, which is an associated white for the blue color family.
Warmer 3037 <page reloads with the whites from the next warmest color>
Cooler 3039 <page reloads with the whites from the next coolest color>
Select this color 3035 <go to Coordination/Similar Colors: FIG. 40 page 2>
Fine 3036 Tune <go to Browse: FIG. 38 page 13>
Start Over <go to Start page 1
Back <go to Browse: FIG. 25 page 1>
   Navigation through the available “whites” is accomplished, for example, by reading from an XML table.

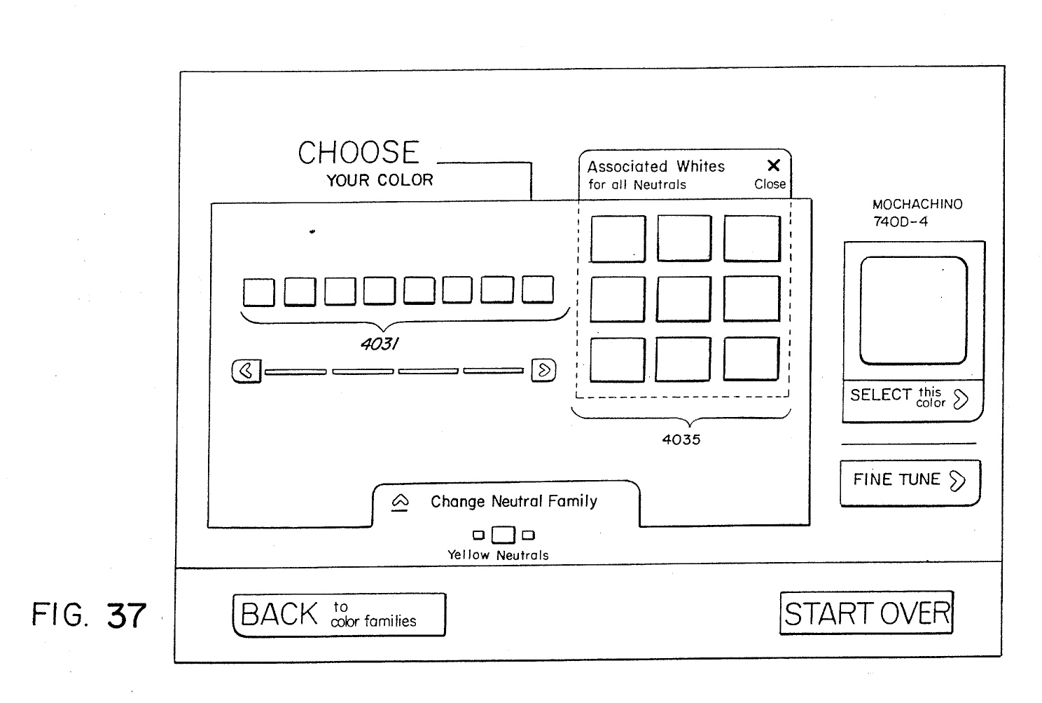

If Neutrals+Associated Whites is selected via link 4030 on FIG. 31, the screen of FIG. 37 appears.
Animation: The color buttons 4031 and related bar reduce in size and animate left making space for 9 white buttons 4035 to animate in on the right of FIG. 37. All hue and all white chips are active and when selected should highlight
No white chip is selected as a default
All 9 whites apply to all 3 neutral groups
If user selects the left arrow or right arrow from the bar mid-page, then page re-loads with appropriate column of neutrals displayed
A hue control bar for neutrals allows users to move to the red, yellow or blue-based neutrals hue, depending on their location
Select this color <go to Coordination/Similar Colors: FIG. 40 page 2>
Fine tune <go to Browse: page 10>
Start Over <go to Start: FIG. 25 page 1>
Back <go to Browse: page 1>

Once the user has selected a color, e.g., on one of the screens of FIG. 26-31, the user may decide to “Fine Tune” the color, via e.g., link 3036. Selecting link 3036 on the screens of FIGS. 26-28 results in the display of the screen shown in FIG. 34, which provides a color tuning “tool”. The color theory behind this tool is numerical, i.e., a number is assigned to each different color in the table, e.g. of FIG. 51, and “tuning” or movement to another color is defined as a move to another number in the table via the XML data table.

The user may fine tune the color via any of the following controls: More bright 3051, Less bright 3053, Lighter 3054, Darker 3055, More 3056 <next hue to the left>, and More 3057 <next hue to the right>. Once a user is happy with his or her color selection, the user selects “Select This Color” <go to Coordination/Similar Colors: FIG. 40 Page 2>. The user may also select “Back”, <go to previous screen> or “Start Over”, which will take the user back to the beginning <go to Start page>. FIG. 35 illustrates that the “more bright” button no longer appears when the user has already selected the brightest color available.

If the user selects the “Fine Tune” link 3036 in the display of FIG. 33, the display of FIG. 38 (p. 13) appears. The user may fine tune the color via these controls: warmer 3061 or cooler 3062. Once a user is happy with his or her color selection, the user selects “Select This Color”<go to Coordination/Similar Colors: FIG. 40 Page 2<. The user may also select “Back”, <go to previous screen> or “Start Over”, which will take them back to the beginning <go to Start page>.

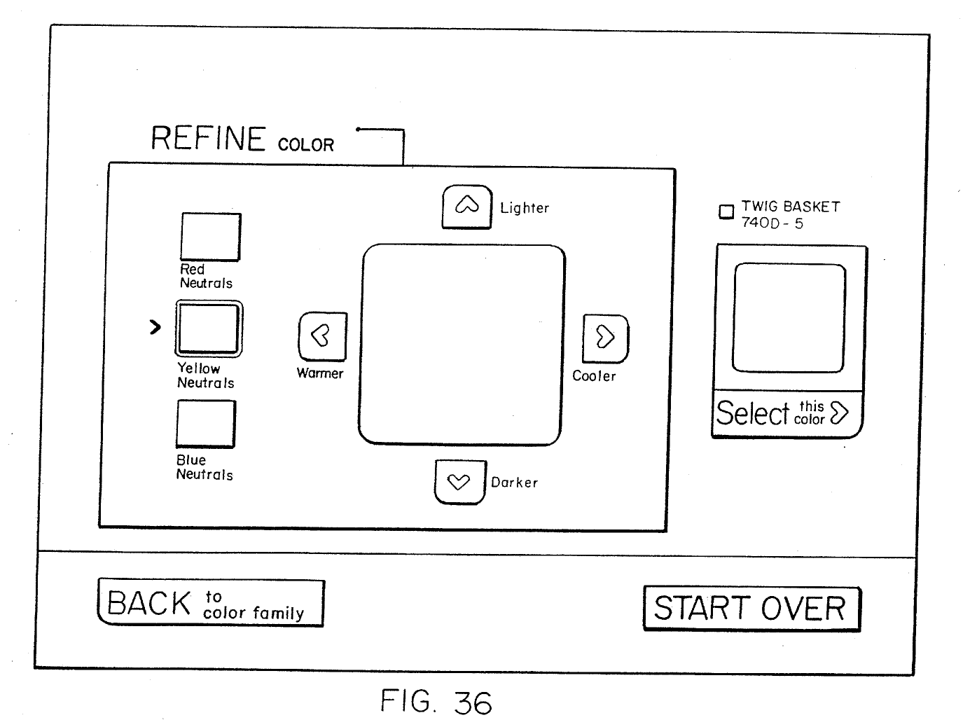

If the user selects “Fine Tune” on the display of FIG. 30, 31, or 32, (i.e., fine tuning of a neutral color) the display of FIG. 36 appears. The color theory behind this tool is again numerical. The user may fine tune the color via any of the following controls:
More <red, yellow or blue>; user cannot traverse to another neutral group through this functionality
Lighter
Darker
Neutral Hue Control bar (red, yellow, blue); user can not traverse to another neutral group through this functionality.

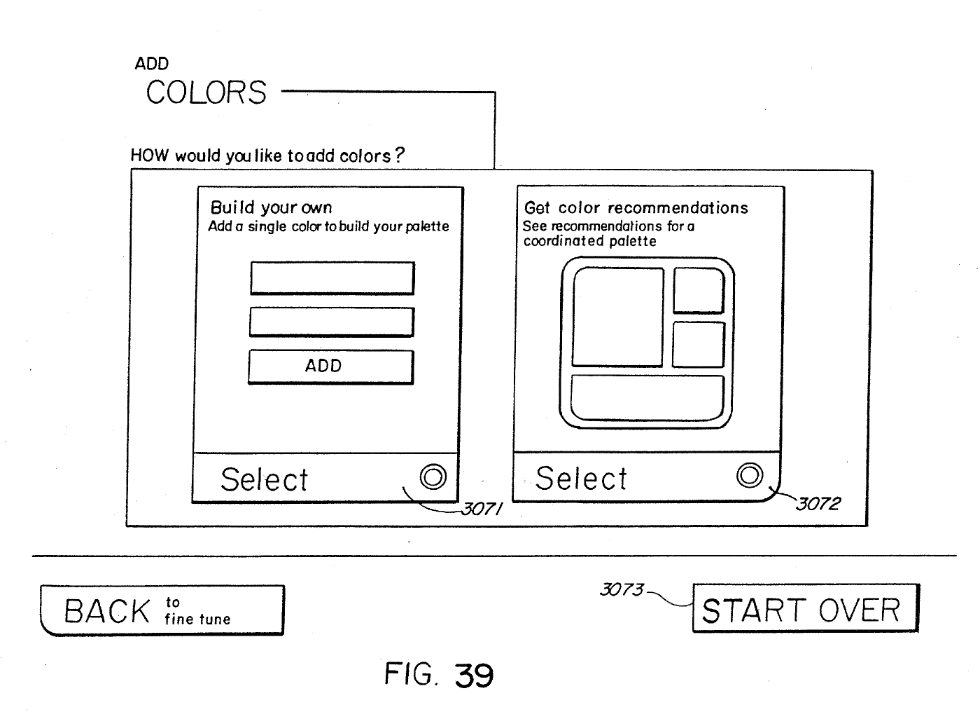

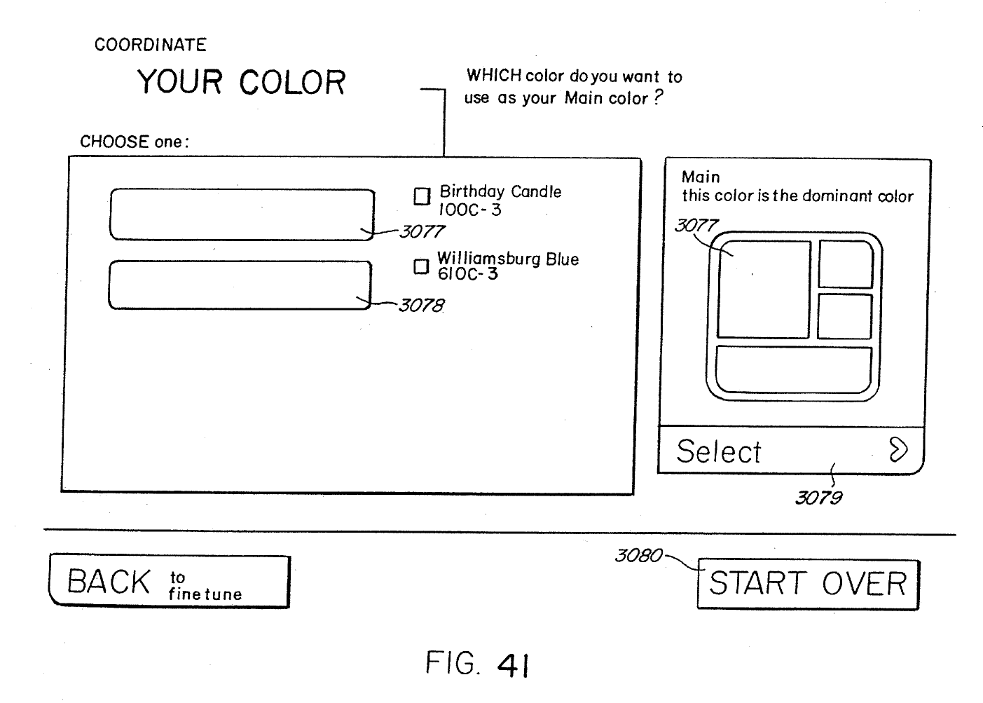

FIGS. 39 to 44 illustrate screens for implementing functionality whereby a user may select a color and then build his or her own color palette. The “Coordinate Similar Colors” screen of FIG. 40 is reached after a single color has been selected, for example, as a result of a scan or browse operation as discussed above. The “Add color” link takes a user to FIG. 21 where the user decides how she or he wants to add color. “Coordinate” takes the user to FIG. 41. Preview/print may lead to a print function for the selected colors.

The first page of the “coordinate” screens, FIG. 39 provides the following functionality:
1. The user may build his or her own palette by selecting the “Build Your Own” link 3071 <go to Start: FIG. 21 page 3>
2. The user may get color recommendations by selecting the “Get Color Recommendations” link 3072 <go to Coordination/Similar Colors: FIG. 42 page 4>
3. The user may “Start Over” link 3073 <go to Start page>

This page (FIG. 39) will not show a full-dynamically generated color coordination palette.

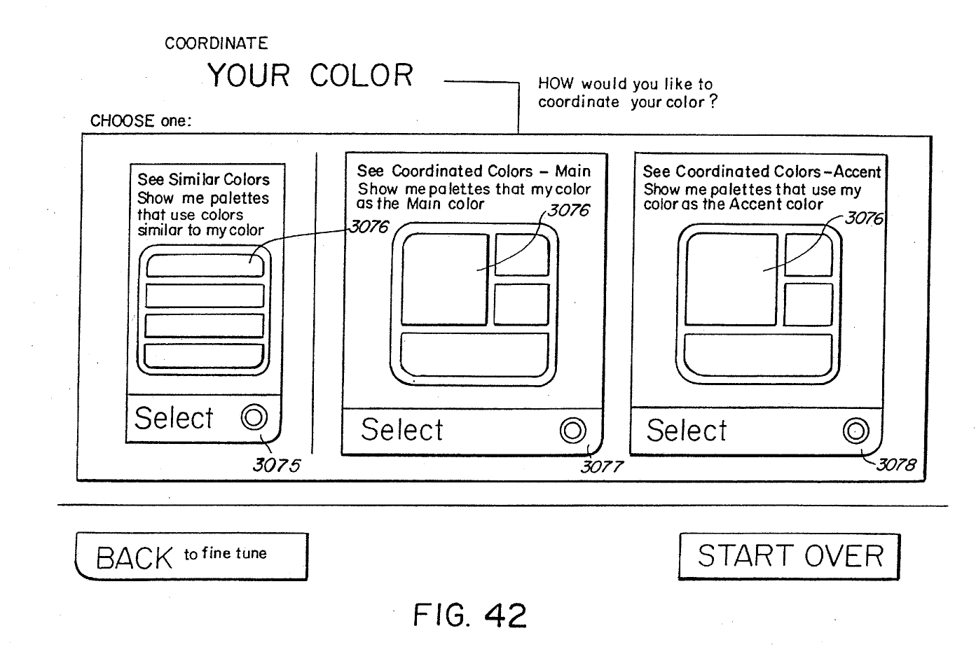

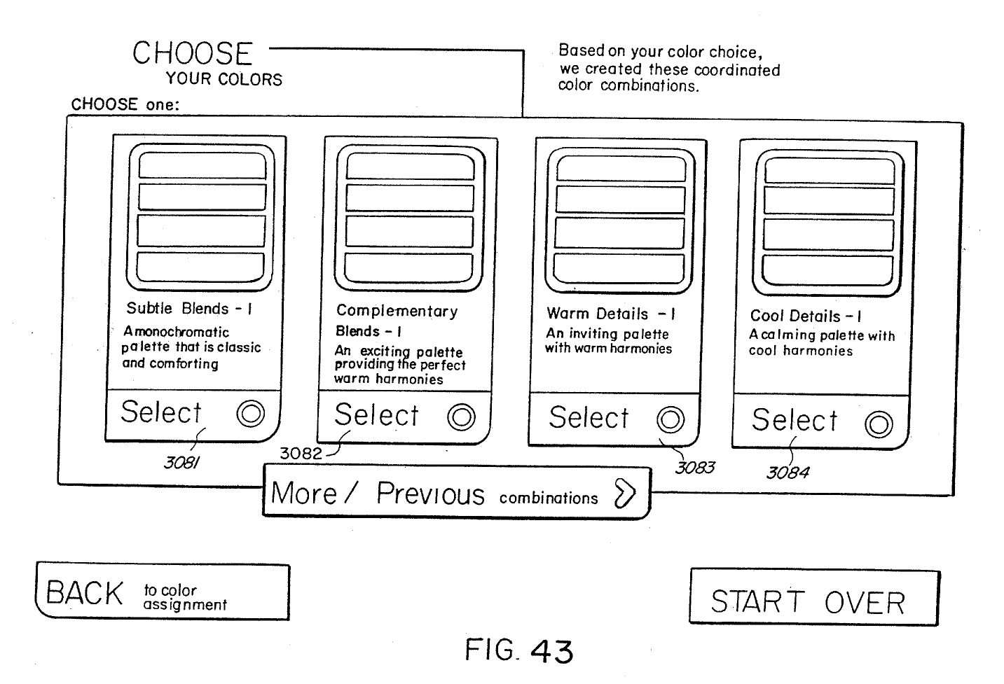

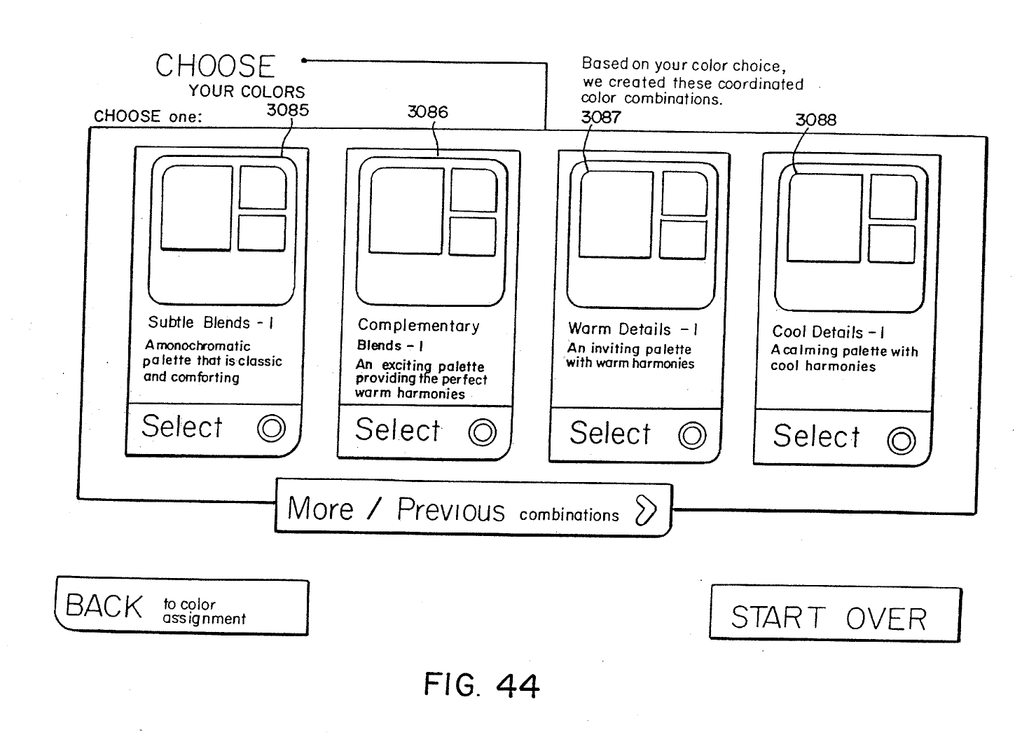

If the user selects “Get color Recommendations” on FIG. 39, the screen of FIG. 42 (page 4) “Coordinate Your Color” is presented. The screen of FIG. 42 provides the following functionality:
1. The user may select to “See Similar Colors”, link 3075, <go to Coordination/Similar colors: FIG. 43 page 5>
2. The user may select “Coordinate with the color 3076 as the main color”, link 3077, <go to Coordination/similar Colors: FIG. 44 page 6>
3. The user may select “Coordinate with the color 3076 as the accent color”, link 3078 <go to Coordination/Similar Colors: FIG. 44 page 6>
4. The user may select “Start Over”<go to Start page>
   This page (FIG. 42) will show a representative, dynamically-generated similar color and coordinated palette to the user, based on their pre-selected color.

With respect to the screen of FIG. 41, (page 3) the user must designate a color as his or her Main color by clicking/touching that color and then clicking/touching the “Select” link 3078 <go to Coordination/Similar Colors: page 6, FIG. 44>. The only other functionality on this page, FIG. 41, is that the user may “Start Over” link 3080 <go to Start: page>. The user navigates to FIG. 41 by hitting “coordinate” on FIG. 40.

Selection of either link 3077 or 3078 on the screen of FIG. 42 or link 3079 on the screen of FIG. 41 initiates display of the screen of FIG. 44, which provides the following functionality:
The user may select one of the coordinated palettes with which to proceed, for example a Palette Home page.
2. The user may select “More” to see more coordinated palette options <reload screen with more palette options (the palette option screens are FIGS. 43 and 44> If “More” is depressed, it is replaced in the next view of screen 49 by the word “Previous” (item 4 below)
3. The user may “Start Over” <go to Start page>
4. “Previous Combinations”
5. The user may go “Back” <go to previous screen>

Selection of the “See Similar Colors” link 3075 on the screen of FIG. 42 initiates display of the screen of FIG. 43 (page 5), which provides the following functionality:
1. The user may select one of the similar palettes with which to proceed via one of the links 3081, 3082, 3083, 3084 <go to Palette Home>
2. The user may select “More” to see more similar palette options (again not shown?) <reload screen with more palette options>
3. The user may “Start Over” <to go Start: page 1>

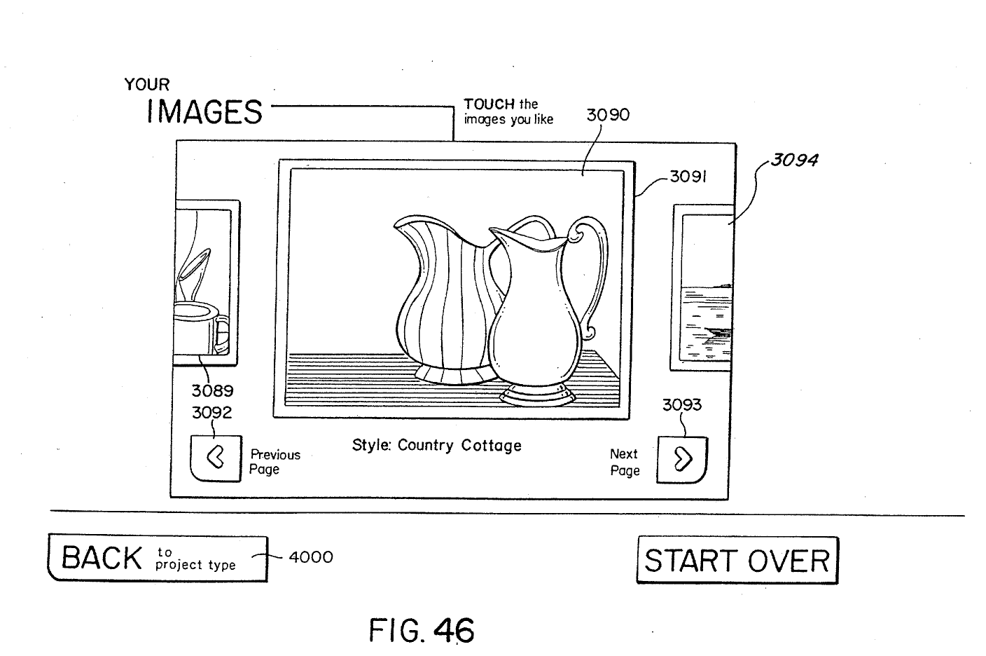

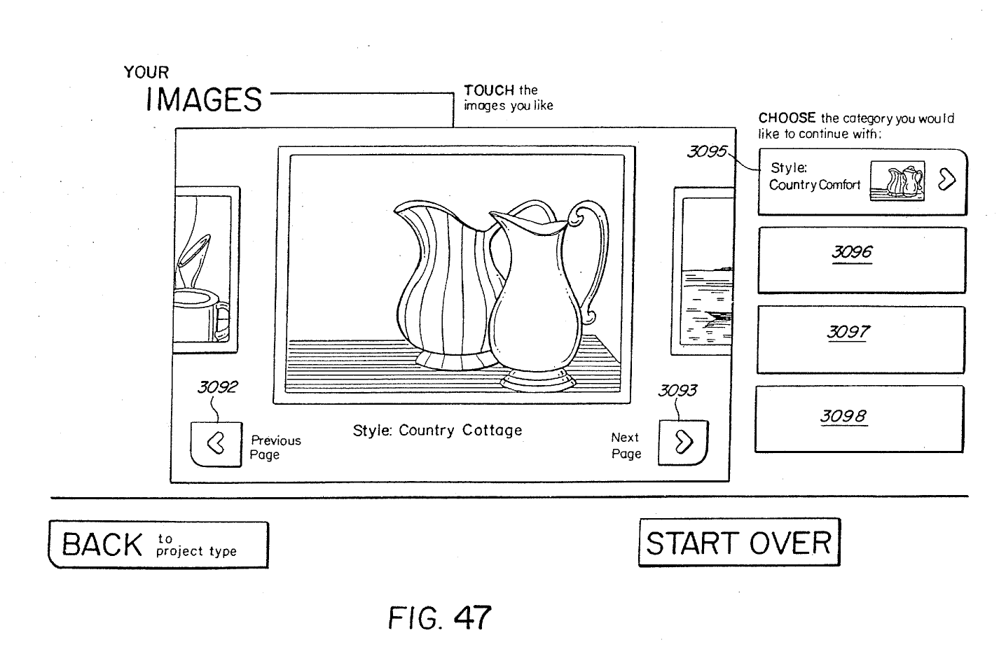

FIGS. 45-50 depict an illustrative embodiment and implementation of an inspirational idea sequence. FIG. 45 permits the user to select either an “interior” or “exterior” inspirational scene via links 4003, 4005. In response to such selection, the screen of FIG. 46 presents an inspirational carousel animation, which cycles through 4 images e.g., 3089, 3091, before landing on the initial image 3090 of the “slide show”. A 4-image cycle is stored for each of the interior and exterior slides. With respect to the screen of FIG. 46, the user is shown a slide show of thumbnails with the initial image 3090 contained in the central and larger box 3091. The user can view other inspirational images, e.g., 3089, 3091, in the center/larger box 3090 by clicking the “previous/next” page icons 3092, 3093. When the user clicks on an image in the central box 3091, the main viewing window animates left and 4 tabs 3095, 3096, 3097, 3098 appear on the right side of the screen with the selected image presented in the top tab 3095, as shown in FIG. 47 <go to Inspiration: FIG. 47 page 3>.

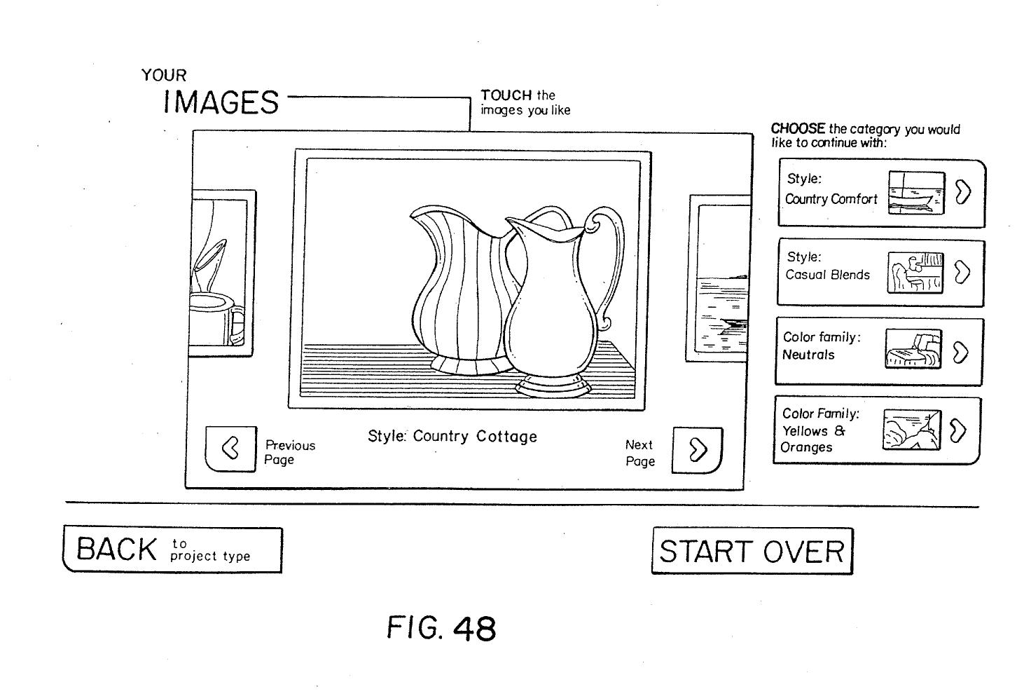

By manipulating the buttons 3092, 3093 on the screen of FIG. 47, the user may select up to 4 thumbnails for insertion into the tabs 3095, 3096, 3097, 3098, each labeled with their category, as illustrated in FIG. 48. The user may also start over <go to Start page>

FIG. 46 refers to the initial state of the category selection screen. After a user has touched a picture, and thus selected a category, the page animates to look like FIG. 47 with the category(ies) the user has chosen populating links 3095-3098. Once at least one image/category has been chosen on the screen of FIG. 46, a user can at any time click the “now available” tabs 3095, 3096, 3097, 3098 on the right of FIG. 46 to see results on the screen of FIG. 48 <go to Inspiration: FIG. 48 page 5> The results are preferably a data set of coordinated inspirational palettes that are organized by color, style, mood, and life stage.

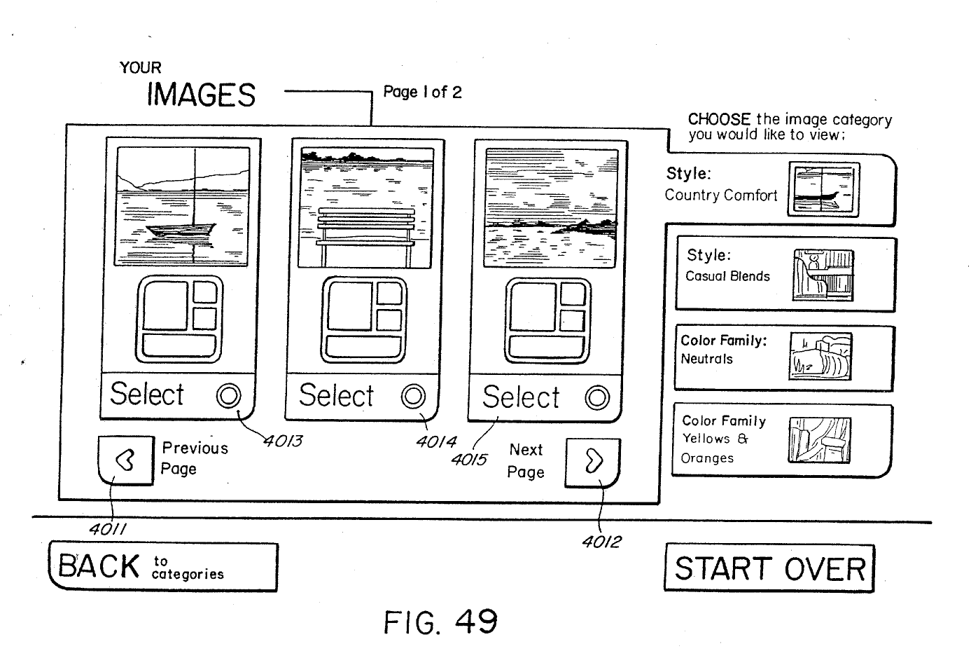

If the user comes back to the page of FIG. 46 from Inspiration page of FIG. 49, the page (FIG. 46) must re-load up to the last 4 images/categories chosen as the buttons at the bottom. Links 3095-3098 on FIG. 47 must be populated with the same categories available on FIG. 49 if “back to categories” is pressed from FIG. 49.

If user has selected 4 thumbnails and then selects a 5th, the 1st thumbnail chosen will be removed (and so on). Finally, the user may go “Back” link 4000 FIG. 46 to select interior/exterior again on FIG. 45.

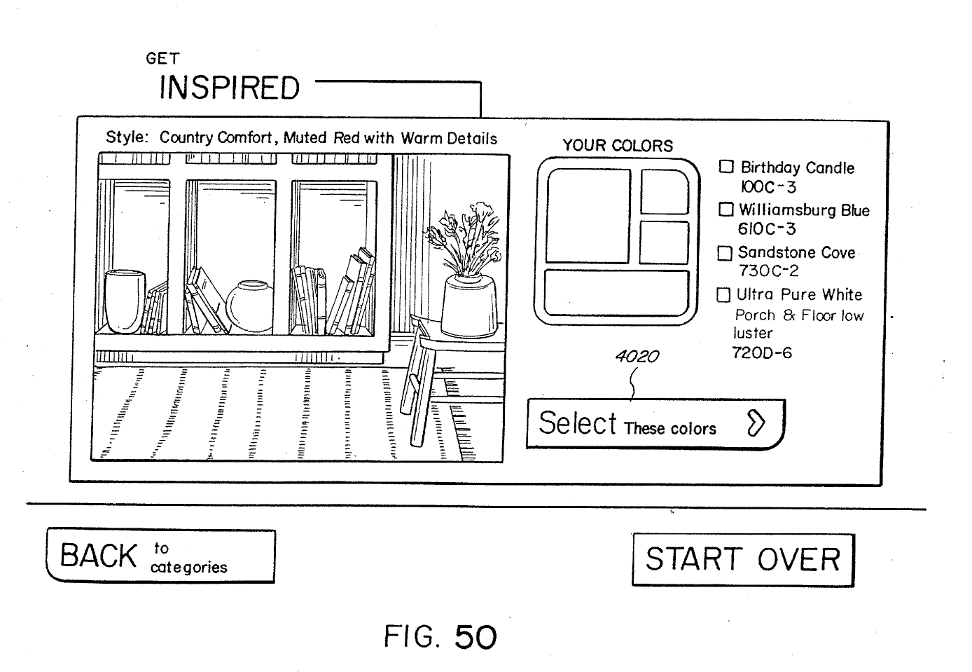

With respect to the screen of FIG. 49 (page 5), the user is shown up to 3 palettes per page of the selected category. In other words, each time a user hits links 4011, 4012 they scroll to the next “page”, or set of 3 palettes, for a given category. Each category can contain a large number of palettes that can be seen only 3 at a time.
1. The user may go “back” to the Slide Show of FIG. 46 and the Slide Show will recall their last 4 choices <go to Inspiration: page 2>
2. The user may select a single palette to move forward with by clicking/touching one of the “Select” links 4013, 4014, 4015<go to Inspiration: page 6, FIG. 50>
3. The user may “start over” <go to Start page>
   When the “Select” link 4020 is chosen on the page of FIG. 50, the user is sent to a palette home page along with the colors from the inspiration palette, which populate the palette home page.

A useful color selection method may be implemented to assist a user to select additional colors to match first and second colors the user has chosen. In an illustrative embodiment of such a method, for any combination of two pre-selected colors, 8 coordinated palettes are created.

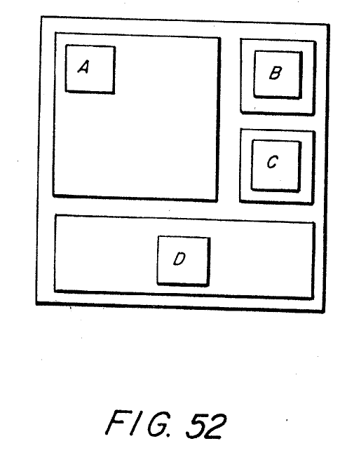

Considering FIG. 52, the first two palettes are tint/shade palettes based on the user selected colors A and B. The same method of color selection is used to generate the first two palettes, regardless of the relationship between colors A and B, according to the following selection criteria:

Palette 1:
A: Known
B: Known
C: If A is light, Color C is a shade of A.
   If A is dark, Color C is a tint of A.
D: White of A
   In the embodiment under discussion, the user selects A from a set of available colors such as those in the table of FIG. 51. The associated “white” for each such color A is stored and retrieved, e.g., by a table look up operation. The “shade” and “tint” of the color are completed in real time. The “shade” may be determined by subtracting “15” from the L value of A while holding the chroma and hue constant. The “tint” may be determined by adding “15” to the L value of A, again holding chroma and hue constant.

Palette 2:
A: Known
B: Known
C: If B is light, Color C is a shade of B
   If B is dark, Color C is a tint of B
D: White of A
   For palette 2, “tint”, “shade” and “white of A” may be determined in the same manner as used for palette 1. To establish whether a known color, e.g., “A” is “light” or “dark for purposes of palettes 1 and 2, color space such as illustrated, in FIG. 53 may be divided into a number of segments (arcs measured in degrees), such as, for example, 36. A selected range of colors, such as 21, in each segment are then considered “dark” and the rest “light.” Alternatively, a selected color in each segment is chosen as a “core” color. Whether color A is “light” or “dark” is then determined by its position with respect to the core color of the segment within which A lies. Lightness or darkness in this context may thus be determined by a software implemented table look up operation.

To create the next six palettes, the relationship between colors A and B is taken into account. First we determine the sector which is formed by two selected colors. Two properties are mainly of interest—angle and warmness or coolness of the sector. The angle for the red-orange portion of the color wheel is defined as follows:

| | |
|---|---|
| No angle | 0°-15° |
| Sharp | 15°-45° |
| Sharp to right | 45°-105° |
| Wide | 105°-135° |
| Ultra-wide | 135°-165° |
| Opposite | 165°-180° |

The respective angle values in yellow-green-blue can be slightly different than that for red-orange.

We assume the warm region of the color wheel as ranging from 315° to 140° counterclockwise; cool region 105°-320° clockwise. The method further avoids using complementary colors for narrow angles for the following reason: the true complement for two colors with hue distance less than 100° will have considerably higher chroma than originating colors; in the same way the chroma of the complement would have significantly smaller value for hue distances larger than 140°, and it is preferred that the chroma stay within the normalized values of two selected colors.

To facilitate discussion of the manner in which the remaining 6 palettes are determined it is assumed that color A is always on the left (counterclockwise) of color B, and color D is always selected as the White of color A. According, the following paragraphs describe the method used to determine Color C for each of the remaining 6 palettes based on the relationships between colors A and B. The determination may be data driven through use of appropriate data structures as discussed for example in connection with Tables 1-7 above.

If A and B are characterized by “No angle”, then color C is selected as illustrated in FIG. 53 and for each of the 6 remaining palettes respectively equals, for the 6 remaining palettes, respectively:

Palette 3: Analogous counterclockwise of A.

Palette 4: Analogous clockwise of B.

Palette 5: Clockwise analogous of a complement to a split.

Palette 6: Counterclockwise analogous of a complement to a split.

Palette 7: Best warm (Calculate the warm triad for each A and B, and select the result that is most warm . . . )

Palette 8: Best cool (Calculate the cool triad for each of A and B, and select the result that is most cool . . . )

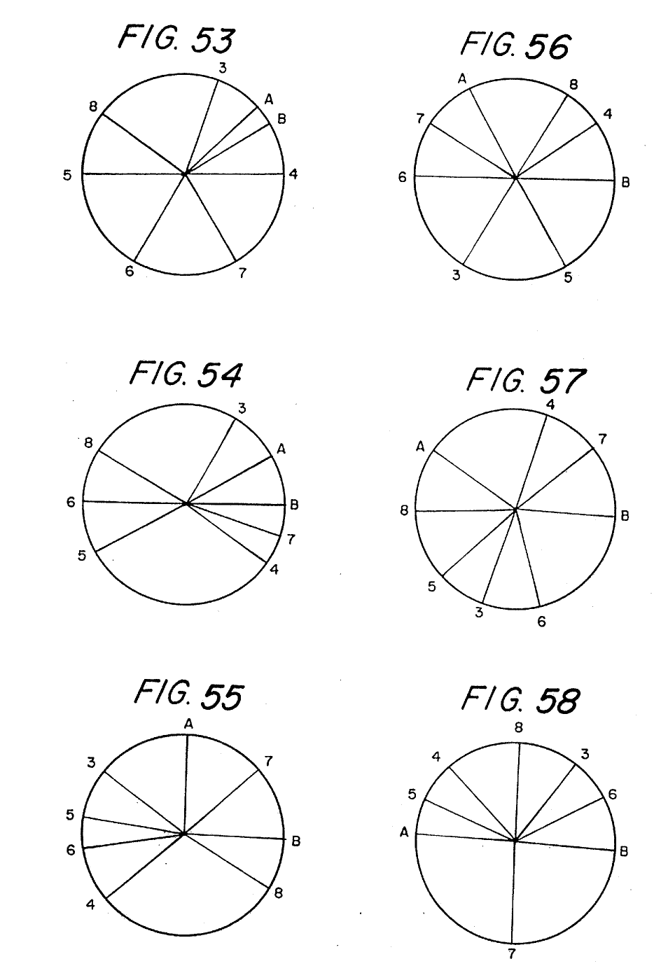

If A and B are characterized as “Sharp”, then color C is selected as illustrated in FIG. 54 and equals:
3. Analogous counterclockwise of A. The analogous angle will have to be adjusted based on the angle between A and B. For example if AB angle is 25° the analogous angle will be 35° to offset the smaller angle between AB. However if the AB angle is 40° that analogous angle should be 40° also to keep the proportion. Thus analogous angle is never less than 30°, but is increased for AB angles less and greater than 30°.
4. Analogous clockwise of B.
5. Complement of A.
6. Complement of B
7. Best warm.
8. Best cool.

If Colors A & B are characterized as “Sharp to right”, then color C is selected as illustrated in FIG. 55 and equals:
3. Warm or cool of A whichever lies counterclockwise.
4. Warm or cool of B whichever lies clockwise.
5. Counterclockwise analogous to (1). At this specific angle we do not use the complement because either (1) or (3) will be the complement of A depending on the angle. Same is true for (4).
6. Clockwise analogous of (2)
   If (5) and (6) are too close, (5) is recalculated as clockwise and (6) as counterclockwise.
7. Cool if (3) is warm and warm is (3) is cool based on A.
8. Cool if (4) is warm and warm is (4) is cool based on B

If the angle is wide, then color C is selected as illustrated in FIG. 56, and equals for the six palettes, respectively:
3. Complement of A and B.
4. If the AB sector is warm the warm palette is created, otherwise cool palette is used. The core color for the palette will not necessarily be the main color. the core is the color that produces third color inside the selected sector.
5. Complement of A
6. Complement of B
7. Opposite of (4). If the AB is war the cool palette is created, otherwise warm palette is used. The core color for the palette will not necessarily be the main color. The color is the color that produces third color inside the selected sector.
8. Split

If angle is ultra wide, then color C is selected as illustrated in FIG. 57 and equals:
3. Complement of A and B.
4. Split
5. Clockwise analogous of a complement to (4). We do not use analogous of a (3) because of the chroma adjustment when calculating the split complement. Same for (6).
6. Counterclockwise analogous of a complement to (4).
7. Best warm
9. Best cool

If A and B are opposite, then C is selected as illustrated in FIG. 58, and equals:
1. Best warm—the warmer of the warm for A and warm for B
2. Best cool—the cooler of the cool for A and cool for B.
3. Analogous of A clockwise.
4. Analogous of B counterclockwise.
5. Split
10. Complement of a split.

In a case where the user has chosen three colors and wishes to have the system provide a matching fourth color, it is difficult to implement a method based on angles as done for two colors. Thus, a different method is preferably used. In particular, for each selected color (A, B, C) the complement, warm, cool and two analogous colors are calculated and are designated AO, AW, AC, AR, AL for color A; BO, BW, BC, BR, BL for color B; and finally CO, CW, CC, CR, CL for C.

The first three palettes are created using tints for selected colors, where color A, color B and color C are known. In such case, the selection method for color D is as follows:
1. If A is light, D=Shade of A. If A is dark, D=Tint of A.
2. If B is light, D=Shade of B. If A is dark, D=Tint of B
3. If C is light, D=Shade of C. If A is dark, D=Tint of C.
   The method disclosed above for determining “tint” and “shade” may again be used.

For the remaining five palettes, calculated colors are added in the following order: Complements first (AO, BO, CO), followed by warm (AW, BW, CW) and cool (AC, BC, CC) and finally analogous (AR, AL, BR, BL, CR, CL). If the new color (AO) is not the same as B, C, or form sharp hue angles with B or C or previously added colors, it is chosen as color D, otherwise the color is rejected and the selection routine moves to the next calculated color. Iterations continue until five D colors are added.

Next, the hue angles are analyzed for all selected colors. If there is a sharp angle (<35 degrees) present between A and B or B and C, the system finds an unused color among the candidate colors that better coordinates with A and C, and discards a previously added color from the heavier populated side of the spectrum.

As may be appreciated, the system of FIGS. 1A-3 may be provided in web site, kiosk or other applications. While such applications may include many of the same features, they may have different interfaces. For instance, because an in-store kiosk may be touch-screen driven, buttons are necessarily large and spread out. This consideration may cause functionality to be spread across various screens in the store that would more efficiently be handled on one screen through the web. To minimize replicated effort, code for access to databases, coordination algorithms, etc., may be shared by two separate platforms (e.g. web/kiosk) wherever possible.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications are possible. Those skilled, in the art will appreciate that various adaptations and modifications of the just described preferred embodiment can be configured without departing from the scope and spirit of the invention. Therefore, it is to be understood that, within the scope of the appended claims, the invention may be practiced other than as specifically described herein.

1. A method comprising:
providing a user with a first plurality of display screens on a display device, each display screen enabling selection of at least one subsequent display screen;
a first subset of said first plurality of display screens enabling the user to select a first color that coordinates with a second color based on at least one user inputted preference;
a second subset of said first plurality of display screens enabling the user to select for purchase one or more of a plurality of interior decorating-related items; providing the user with a second plurality of display screens enabling the user to order and pay for one or more of (a) a paint sample of each of said first and second colors and (b) at least one of said interior decorating-related items reflecting at least the coordinated first color and second color;
automatically transmitting said order to a fulfillment center for fulfillment; and delivering the fulfilled order to the user.

2. The method of claim 1 wherein said first plurality of screens includes a third subset comprising an inspiration article page enabling the user to select for review one of a plurality of decorating-related motivational articles.

3. The method of claim 2 wherein said third subset further enables selection of an inspiration pop-up window displaying an inspirational interior scene to the user together with a pre-selected color palette related to that scene.

4. The method of claim 1 wherein said plurality of interior decorating items includes a designer kit comprising a plurality of containers, each container containing a different paint sample of a pre-selected color.

5. The method of claim 4 wherein the number of containers is four.

6. The method of claim 1 wherein said plurality of interior decorating items includes a plurality of designer kits, each kit associated with a different design style and containing a plurality of containers, each containing a different paint sample of a pre-selected color.

7. The method of claim 6 wherein the number of containers is four.

8. The method of claim 1 wherein said plurality of interior decorating items further includes a plurality of brochures, each facilitating paint color selection.

9. The method of claim 1 wherein said plurality of interior decorating items includes at least one fan deck color selector.

10. The method of claim 1 wherein said plurality of interior decorating items includes a plurality of color carrying preview swatches.

11. A method comprising:
entering a website via a home page;
proceeding from said home page to select a plurality of coordinated colors to be used in a decorating project through manipulation of a plurality of display screens generated with the assistance of color selection and coordination computer software;
ordering and purchasing a paint sample of each color so selected on-line at said website;
receiving delivery of each of said samples; and
applying each of said paint samples to confirm its suitability for the project.

12. The method of claim 11 further comprising the step of returning to said website to order quantities of paint in an amount selected to complete said project.

13. A website structure comprising:
a home page;
a color selection landing page for generating at least one coordinated palette;
a color shop landing page;
an inspiration article page;
the home page providing a selectable link to each of the color selection landing page, the color shop landing page and the inspiration article page;
the color shop landing page providing links to a plurality of pages which enable purchase of one or more of the following: one or more designer kits, one or more paint samples, one or more brochures and at least one fan deck color selector.

14. Computer software stored on a computer readable medium or media and operable in conjunction with a computer processor for:
providing a user with a first plurality of display screens on a display device, each display screen enabling selection of at least one subsequent display screen;
a first subset of said first plurality of display screens enabling the user to select a first color that coordinates with a second color based on at least one user inputted preference;
a second subset of said first plurality of display screens enabling the user to select for purchase one or more of a plurality of interior decorating-related items; providing the user with a second plurality of display screens enabling the user to order and pay for one or more of (a) a paint sample of each of said first and second colors and (b) at least one of said interior decorating-related items reflecting at least the coordinated first color and second color;
automatically transmitting said order to a fulfillment center for fulfillment; and delivering the fulfilled order to the user.

15. The method of claim 14 wherein said first plurality of screens includes a third subset comprising an inspiration article page enabling the user to select for review one of a plurality of decorating-related motivational articles.

16. The method of claim 15 wherein said third subset further enables selection of an inspiration pop-up window displaying an inspirational interior scene to the user together with a pre-selected color palette related to that scene.

17. The method of claim 14 wherein said plurality of interior decorating items includes a designer kit comprising a plurality of containers, each container containing a different paint sample of a pre-selected color.

18. The method of claim 17 wherein the number of containers is four.

19. The method of claim 14 wherein said plurality of interior decorating items includes a plurality of designer kits, each kit associated with a different design style and containing a plurality of containers, each containing a different paint sample of a pre-selected color.

20. The method of claim 19 wherein the number of containers is four.

21. The method of claim 14 wherein said plurality of interior decorating items further includes a plurality of brochures, each facilitating paint color selection.

22. The method of claim 14 wherein said plurality of interior decorating items includes at least one fan deck color selector.

23. The method of claim 14 wherein said plurality of interior decorating items includes a plurality of color carrying preview swatches.

24. A website structure comprising:
a home page, the home page providing a selectable link to a color shop landing page;
the color shop landing page providing links to a plurality of pages which enable purchase of one or more of the following: one or more designer kits, one or more paint samples, one or more brochures and at least one fan deck color selector.

25. A website structure comprising:
a home page, the home page providing a selectable link to an inspiration article page;
the inspiration article page enabling the user to select for review one of a plurality of decorating-related motivational articles.

26. The method of claim 25 wherein said inspiration article page further enables selection of an inspiration pop-up window displaying an inspirational interior scene to the user together with a pre-selected color palette related to that scene.

27. A method comprising:
providing a user with a first plurality of display screens on a display device, a first of said display screens comprising a home page, the home page displaying a set of user-selectable links across an upper edge thereof;
responding to user selection of a first of said links by linking the user to a paint color selection application program for assisting the user in selecting and coordinating colors;
responding to user selection of a second of said links by linking the user to a second display screen providing a plurality of product links, each product link providing a link to information regarding one of a plurality of paint color selection products, one of said products comprising paint sample containers; and
responding to user selection of a third of said links by linking the user to one of a plurality of inspiration-related display screens for inspiring color selection by the user, at least one of said inspiration-related display screens providing a plurality of inspirational links, each said inspirational link representing a selected category of inspiration.

28. The method of claim 27 wherein said home page further comprises a display of a scene, said scene including a depiction of a paintable object, said home page further including a plurality of informational blocks arranged around said scene, a first of said informational blocks containing an additional link to said color selection application program, a second of said blocks containing an additional link to one of said inspiration-related display screens, and a third of said blocks containing an additional link to said second display screen.

29. The method of claim 28 wherein at least one of said inspiration-related display screens provides a display of a plurality of different inspirational images falling within one of said categories, and wherein each of said plurality of inspirational images links to a pop-up window providing an enlarged view of said image together with a pre-selected color palette related to said enlarged image.

30. The method of claim 29 wherein said color palette comprises a primary color block and a plurality of adjacently positioned color blocks, each adjacently positioned color block containing a color which coordinates with the color contained in the primary color block.

31. The method of claim 30 wherein said second display screen employs a “learn more” icon to identify each of said plurality of product links.

32. The method of claim 31 wherein the set of user-selectable links further includes a link to expert advice.

33. The method of claim 32 wherein:
said color selection program enables the user to select a first color which coordinates with a second color and wherein said first plurality of display screens further includes
a second plurality of display screens enabling the user to select for purchase one or more of a plurality of interior decorating-related items; and wherein said method further includes the step of:
providing the user with a third plurality of display screens enabling the user to order and pay for one or more of (a) a paint sample of each of said first and second colors and (b) at least one of said interior decorating-related items.

34. The method of claim 33 further including the steps of:
automatically transmitting said order to a fulfillment center for fulfillment; and delivering the fulfilled order to the user.

35. A method comprising:
providing a user with a first plurality of display screens on a display device, a first subset of said first plurality of display screens enabling the user to select a first color which coordinates with a second selected color; and
providing the user with a second plurality of display screens for inspiring color selection by the user, wherein at least one of said second plurality of display screens provides a display of a plurality of different inspirational images falling within a selected category of inspiration, and wherein each of said plurality of inspirational images links, when selected, causes generation of a pop-up window of an enlarged view of the corresponding image together with a pre-selected color palette related thereto.

36. The method of claim 35 wherein said color palette comprises a primary color block and a plurality of adjacently positioned coordinated color blocks.

37. The method of claim 35 further including the steps of:
providing the user with a third set of display screens enabling the user to select for purchase one or more of a plurality of interior decorating-related items; and
providing the user with a fourth set of display screens enabling the user to order and pay for one or more of (a) a paint sample of each of said first and second colors and (b) at least one of said interior decorating-related items.

38. The method of claim 37 further including the steps of automatically transmitting said order to a fulfillment center for fulfillment; and delivering the fulfilled order to the user.
